(19) United States
(12) Patent Application Publication
(10) Pub. No.: US 2024/0187824 A1
(43) Pub. Date: Jun. 6, 2024

(54) Using Semi-Persistent and Dynamic Scheduling for Multicast and Broadcast Services

(71) Applicant: GOOGLE LLC, Mountain View, CA (US)

(72) Inventor: Chih-Hsiang Wu, Taoyuan City (TW)

(21) Appl. No.: 18/556,087

(22) PCT Filed: Apr. 18, 2022
(86) PCT No.: PCT/US22/25251

§ 371 Date: Oct. 18, 2023

Related U.S. Application Data
(60) Provisional application No. 63/176,348, filed on Apr. 18, 2021.

(51) Int. Cl. H04W 4/06; H04L 1/1812; H04W 72/11

(52) U.S. Cl. CPC H04W 4/06; H04L 1/1816; H04W 72/11

(57) ABSTRACT

A method in a base station for managing multicast and/or broadcast services (MBS) includes transmitting first data associated with a first MBS to a plurality of UEs, using semi-persistent scheduling (SPS) resources: scrambling a downlink control information (DCI) using a group RNTI (G-RNTI) shared by the plurality of UEs; transmitting the DCI to the plurality of UEs, to schedule transmitting of second data; and transmitting second data associated with the first MBS or a second MBS to at least one of the plurality of UEs, using dynamic scheduling.

### FIELD OF THE DISCLOSURE

This disclosure relates to wireless communications and, more particularly, to using semi-persistent scheduling (SPS) as well as dynamic scheduling for multicast and/or broadcast services (MBS).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems, the Packet Data Convergence Protocol (PDCP) sublayer of the radio protocol stack provides services such as transfer of user-plane data, ciphering, integrity protection, etc. For example, the PDCP layer defined for the Evolved Universal Terrestrial Radio Access (EUTRA) radio interface (see 3GPP specification TS 36.323) and New Radio (NR) (see 3GPP specification TS 38.323) provides sequencing of protocol data units (PDUs) in the uplink direction (from a user device, also known as a user equipment (UE), to a base station) as well as in the downlink direction (from the base station to the UE). Further, the PDCP sublayer provides services for signaling radio bearers (SRBs) to the Radio Resource Control (RRC) sublayer. The PDCP sublayer also provides services for data radio bearers (DRBs) to a Service Data Adaptation Protocol (SDAP) sublayer or a protocol layer such as an Internet Protocol (IP) layer, an Ethernet protocol layer, and an Internet Control Message Protocol (ICMP) layer. Generally speaking, the UE and a base station can use SRBs to exchange RRC messages as well as non-access stratum (NAS) messages, and can use DRBs to transport data on a user plane.

Base stations that operate according to fifth-generation (5G) New Radio (NR) requirements support significantly larger bandwidth than fourth-generation (4G) base stations. Accordingly, the Third Generation Partnership Project (3GPP) has proposed that for Release 15, user equipment units (UEs) support a 100 MHz bandwidth in frequency range 1 (FR1) and a 400 MHz bandwidth in frequency range (FR2). Due to the relatively wide bandwidth of a typical carrier, 3GPP has proposed that for Release 17, a 5G NR base station can provide multicast and/or broadcast services (MBS) to UEs that can be useful in many content delivery applications, such as transparent IPv4/IPv6 multicast delivery, IPTV, software delivery over wireless, group communications, IoT applications, V2X applications, and emergency messages related to public safety.

To provide multicast and/or broadcast service (MBS), a base station can configure multiple UEs with a common frequency resource (CFR) and a physical downlink control channel (PDCCH) configuration configuring a group-common PDCCH, as well as a group-common radio network temporary identifier (RNTI). The base station then can send, on the group-common PDCCH, a downlink control information (DCI) with a cyclic redundancy check (CRC) scrambled by the group-common RNTI to schedule a PDSCH transmission including MBS data packet(s). The UEs also use the group-common RNTI to receive physical downlink shared channel (PDSCH) transmissions including MBS data packet(s).

It was proposed recently to use semi-persistent scheduling for MBS transmissions. However, it is not clear how base stations should configure such transmissions, how base stations and UEs should handle failed transmissions, or how base stations should transmit MBS data packets that exceed the capacity of SPS resources.

### SUMMARY

A base station of this disclosure can augment SPS resources for MBS data with dynamic resources. The base station can allocate such dynamic resources when one of the UEs receiving MBS data has transmitted a negative acknowledgement (e.g., a negative HARQ acknowledgement) for a transmission or has not provided a positive acknowledgement, for example. The base station also can allocate dynamic resources for larger data transmissions, and transmit these larger data transmissions over only the dynamic resources or partially over the dynamic resources. When configuring dynamic resources, the base station can transmit group-common DCIs or UE-specific DCIs. To this end, the base station can utilize group-common or UE-specific temporary identifiers as RNTIs.

An another embodiment of these techniques is a method in a base station for managing MBS. The method includes transmitting first data associated with a first MBS to a plurality of UEs, using SPS resources; and transmitting second data associated with the first MBS or a second MBS to at least one of the plurality of UEs, using dynamic scheduling.

Another embodiment of these techniques is a method in a base station for managing MBS. The method includes transmitting first data associated with a first MBS to a plurality of UEs, using SPS resources; determining that a UE included in the plurality of UEs failed to receive a data packet included in the first data; transmitting, to the UE, a DCI scrambled using a temporary identifier specific to the UE; and retransmitting the data packet in accordance with the DCI and using the SPS resources.

Still another embodiment of these techniques is a base station including processing hardware and configured to implement one of the methods above.

Another example embodiment of these techniques is a method in a UE for receiving MBS. The method includes receiving, from a radio access network (RAN), first data associated with a first MBS, via SPS resources; and receiving, from the RAN, second data associated with the first MBS or a second MBS, via a dynamically scheduled resource.

Another embodiment of these techniques is a method in a UE for managing MBS. The method includes receiving, from a RAN, first data associated with a first MBS, via SPS resources; providing, to the RAN, an indication that the UE failed to receive a data packet included in the first data; receiving, from the RAN, a DCI scrambled using a temporary identifier specific to the UE; and receiving a retransmission of the data packet in accordance with the DCI and via the SPS resources.

Yet another example embodiment of these techniques is a base station including processing hardware and configured to implement one of the methods above.

### BRIEF DESCRIPTION OF THE DRAWINGS

FIG. 1A is a block diagram of an example communication system in which MBS transmission techniques of this disclosure can be implemented;

FIG. 1B is a block diagram of a base station of FIG. 1A implemented in a distributed manner;

FIG. 2 is a block diagram of an example communication stack which some of the network devices of FIG. 1A can implement;

FIG. 3A is a messaging diagram of an example scenario in which a base station dynamically allocates resources upon detecting that at least one of the UEs failed receive an MBS transmission, using a DCI common to multiple UEs (a “group-common DCI”);

FIG. 3B is a messaging diagram of an example scenario in which a base station dynamically allocates resources upon detecting that the size of a certain MBS transmission exceeds the capacity of the corresponding SPS resource, using a group-common DCI;

FIG. 3C is a messaging diagram of an example scenario in which a base station dynamically allocates resources upon detecting that at least one of the UEs failed receive an MBS transmission, using a DCI specific to a UE;

FIG. 3D is a messaging diagram of an example scenario in which a base station dynamically allocates resources upon detecting that the size of a certain MBS transmission exceeds the capacity of the corresponding SPS resource, using a DCI specific to a UE;

FIG. 3E illustrates a scenario similar to that of FIG. 3C, but with the base station using a group-common RNTI for the data transmission performed in accordance with the DCI specific to the UE;

FIG. 3F illustrates a scenario similar to that of FIG. 3D, but with the base station using a group-common RNTI for the data transmission performed in accordance with the DCI specific to the UE;

FIG. 4A is a messaging diagram of an example scenario in which a base station configures different respective SPS resources for different MBSs, which may have different QoS requirements;

FIG. 4B is a messaging diagram of an example scenario in which a base station configures new SPS resources to replace previously configured SPS resources, for one or more MBSs;

FIG. 4C is a messaging diagram of an example scenario in which a base station configures new SPS resources to augment previously configured SPS resources, such that a certain MBS can use both the previously configured SPS resources as well as the new SPS resources;

FIG. 4D is a messaging diagram of an example scenario in which a base station configures SPS resources for one MBS, and dynamic resources for another MBS, for concurrent use with certain one or more UEs;

FIG. 5A is a flow diagram of an example method in a base station for retransmitting MBS data using a DCI scrambled by a temporary identity common to multiple UEs (“group-common identity”), in response to receiving a negative HARQ acknowledgement from one or more UEs;

FIG. 5B is a flow diagram of an example method in a base station for retransmitting MBS data using a DCI scrambled with a UE-specific temporary identity, in response to receiving a negative HARQ acknowledgement from one or more UEs;

FIG. 5C is a flow diagram of an example method in a base station for retransmitting, using unicast and a DCI scrambled with a UE-specific temporary identity, data associated with an MBS, in response to receiving a negative HARQ acknowledgement from one or more UEs;

FIG. 5D is a flow diagram of an example method in a base station for retransmitting MBS data using a DCI scrambled with a UE-specific temporary identity, upon determining that a positive acknowledgement has not arrived from at least one of the UEs;

FIG. 5E is a flow diagram of an example method in a base station for retransmitting, using unicast and a DCI scrambled with a UE-specific temporary identity, data associated with an MBS, upon determining that a positive acknowledgement has not arrived from at least one of the UEs;

FIG. 6A is a flow diagram of an example method in a base station for determining, based on the timing of an available time slot relative to SPS time slots, whether the base station should perform a retransmission of MBS data using HARQ mechanism, in response to receiving a negative HARQ acknowledgement from one or more the UEs receiving MBS data;

FIG. 6B is a flow diagram of an example method in a base station for determining, based on the timing of an available time slot relative to SPS time slots, whether the base station perform a retransmission of MBS data using HARQ mechanism, upon determining that a positive acknowledgement has not arrived from at least one of the UEs;

FIG. 7A is a flow diagram of an example method in a base station for using a group-common radio network temporary identifier (RNTI) for dynamically augmenting SPS transmissions, and subsequently selecting a retransmission technique when one or more of the UEs fail to receive the dynamic transmission;

FIG. 7B is a flow diagram of an example method in a base station for using a UE-specific RNTI for dynamically augmenting SPS transmissions, and subsequently selecting a retransmission technique when one or more of the UEs fail to receive the dynamic transmission;

FIG. 7C is a flow diagram of an example method in a base station for using a UE-specific RNTI and unicast transmissions for dynamically augmenting SPS transmissions, and subsequently selecting a retransmission technique when one or more of the UEs fail to receive the dynamic transmission;

FIG. 8A is a flow diagram of an example method in a base station for configuring a dynamic transmission in response to determining that a data packet associated with an MBS exceeds capacity of SPS resources, and using a group-common RNTI and multicast/broadcast techniques for the dynamic transmission of the portion of the data packet that exceeds the SPS capacity;

FIG. 8B is a flow diagram of an example method similar to that of FIG. 8A, but with the base station using a UE-specific RNTI and multicast/broadcast techniques for the dynamic transmission;

FIG. 8C is a flow diagram of an example method similar to that of FIG. 8A, but with the base station using a UE-specific RNTI and unicast techniques for the dynamic transmission;

FIG. 8D is a flow diagram of an example method in a base station for configuring a dynamic transmission in response to determining that a data packet associated with an MBS exceeds capacity of SPS resources, and using a group-common RNTI and multicast/broadcast techniques for the dynamic transmission of the data packet;

FIG. 8E is a flow diagram of an example method similar to that of FIG. 8D, but with the base station using a UE-specific RNTI and multicast/broadcast techniques for the dynamic transmission;

FIG. 8F is a flow diagram of an example method similar to that of FIG. 8D, but with the base station using a UE-specific RNTI and unicast techniques for the dynamic transmission;

FIG. 9 is a flow diagram of an example method in a UE transmitting a negative acknowledgement to an MBS transmission and receiving, in response, an indication that the base station has allocated a dynamic resource for retransmitting the MBS data;

FIG. 10 is a flow diagram of an example method in a UE for receiving MBS data in accordance with SPS and dynamic scheduling, and determining the type of the dynamic transmission based on the temporary identifier the base station used;

FIG. 11 is a flow diagram of an example method in a base station for selecting a temporary identifier for scrambling downlink transmissions, depending on whether the data is for unicasting or multicasting/broadcasting;

FIG. 12 is a flow diagram of an example method in a base station for transmitting MBS data to multiple UEs using a group-common RNTI for the data and UE-specific RNTIs for DCIs;

FIG. 13A is a flow diagram of an example method in a UE for determining which RNTI the UE should use to receive MBS data, based on an indication in the DCI; and

FIG. 13B is a flow diagram of an example method in a UE for determining which RNTI the UE should use to receive MBS data, based on a configuration other than the DCI, received from the RAN.

### DETAILED DESCRIPTION OF THE DRAWINGS

Generally speaking, a base station of this disclosure allocates resources for MBS information, such as sequences of data packets and the associated control information, using SPS along with dynamic scheduling of resources or with dynamic indications of SPS resources. A UE of this disclosure receives MBS via SPS and dynamic resources, or via SPS only with dynamic indications of SPS resources.

The base station can configure different radio resources in one or multiple overlapping cells to multicast or broadcast (“multicast” or “broadcast” interchangeably referred to as “transmit”) MBS data (and associated control information) and/or unicast (“unicast” interchangeably referred to as “transmit”) non-MBS data (and associated control information) with one or multiple UEs on the downlink (DL). The base station can also unicast MBS data (and associated control information) to a UE on a dedicated DRB for the UE. The one or more multiple UEs can transmit (i.e., unicast) non-MBS data to the base station on the uplink (UL).

To support these communications, the base station can configure one or more radio bearers to transmit MBS information (i.e., MBS data packets and/or control information) to a UE. A radio bearer that carries MBS information to the UE can be a unicast DRB (i.e., a dedicated DRB for the UE) or a multicast DRB (i.e., a DRB that may be shared by multiple UEs, also referred to as an MBS radio bearer or MRB). For example, the base station can transmit unicast configuration parameters or multicast configuration parameters to the UE to configure the UE to receive MBS information via a unicast DRB or a multicast DRB, respectively. As used in this disclosure, the term DRB may refer to a unicast DRB or a multicast DRB, unless specifically noted otherwise.

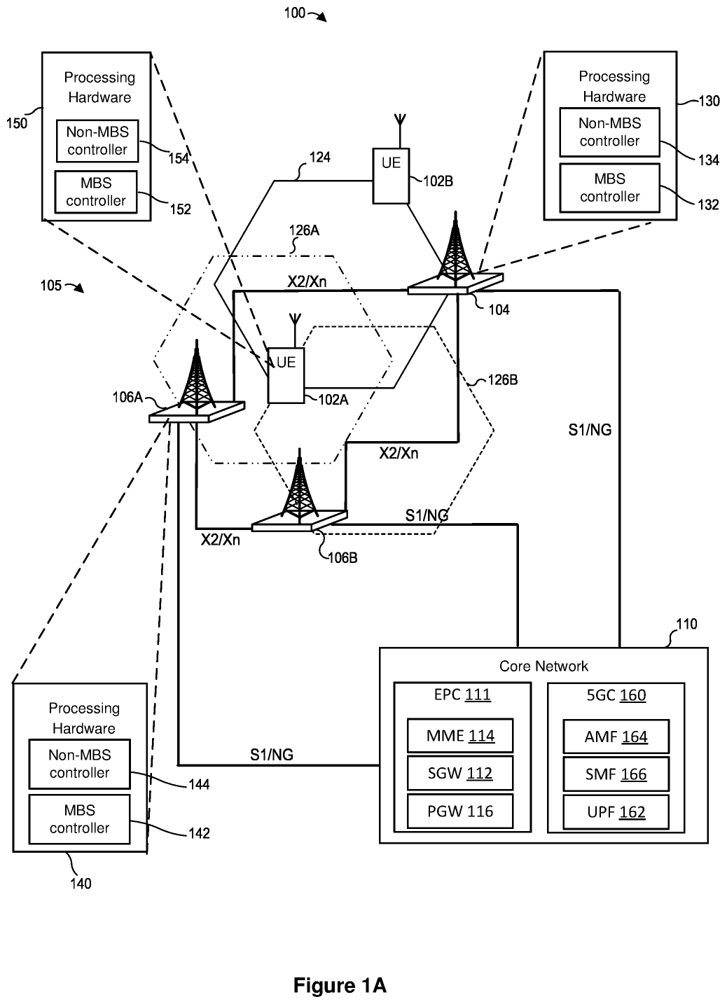

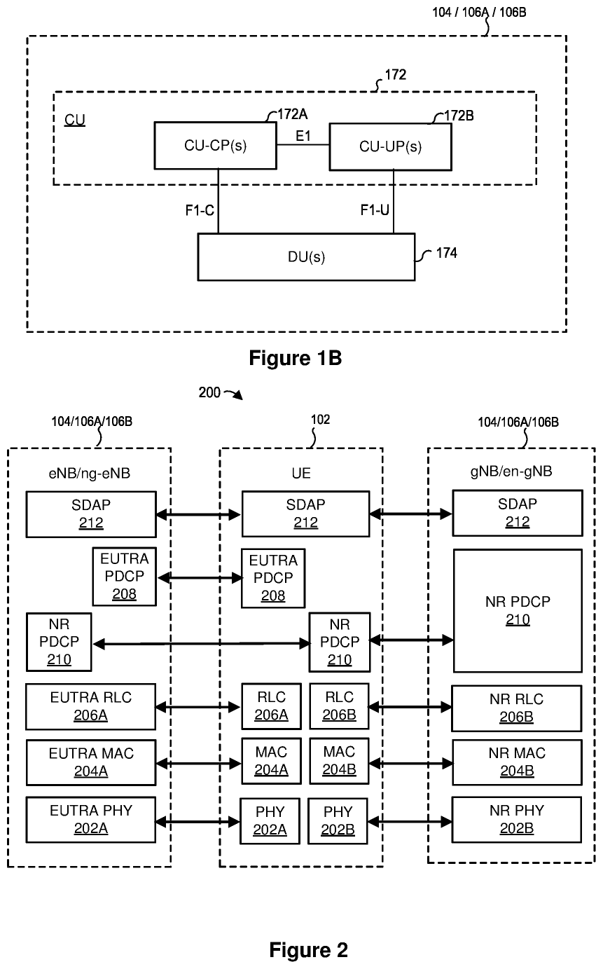

FIG. 1A depicts an example wireless communication system 100 that can implement MBS operation techniques of this disclosure. The wireless communication system 100 includes UE 102A and UE 102B, as well as base stations 104, 106A, 106B of a radio access network (RAN) (e.g., RAN 105) that are connected to a core network (CN) 110. To case readability, UE 102 is used herein to represent the UE 102A, the UE 102B, or both the UE 102A and UE 102B, unless otherwise specified. The base stations 104, 106A, 106B can be any suitable type, or types, of base stations, such as an evolved node B (eNB), a next-generation eNB (ng-eNB), or a 5G Node B (gNB), for example. As a more specific example, the base station 104 can be an eNB or a gNB, and the base stations 106A and 106B can be gNBs.

The base station 104 supports a cell 124, the base station 106A supports a cell 126A, and the base station 106B supports a cell 126B. The cell 124 partially overlaps with both of cells 126A and 126B, such that the UE 102 can be in range to communicate with base station 104 while simultaneously being in range to communicate with base station 106A or 106B (or in range to detect or measure the signal from both base stations 106A and 106B). The overlap can make it possible for the UE 102 to hand over between cells (e.g., from cell 124 to cell 126A or 126B) or base stations (e.g., from base station 104 to base station 106A or base station 106B) before the UE 102 experiences radio link failure, for example. Moreover, the overlap allows the UE 102 to operate in dual connectivity (DC) with the RAN 105. For example, the UE 102 can communicate in DC with the base station 104 (operating as a master node (MN)) and the base station 106A (operating as a secondary node (SN)) and, upon completing a handover to base station 106B, can communicate with the base station 106B (operating as an MN). As another example, the UE 102 can communicate in DC with the base station 104 (operating as an MN) and the base station 106A (operating as an SN) and, upon completing an SN change, can communicate with the base station 104 (operating as an MN) and the base station 106B (operating as an SN).

More particularly, when the UE 102 is in DC with the base station 104 and the base station 106A, the base station 104 operates as a master eNB (MeNB), a master ng-eNB (Mng-eNB), or a master gNB (MgNB), and the base station 106A operates as a secondary gNB (SgNB) or a secondary ng-eNB (Sng-eNB).

In non-MBS (i.e., unicast) operation, the UE 102 can use a radio bearer (e.g., a DRB or an SRB) that at different times terminates at an MN (e.g., the base station 104) or an SN (e.g., the base station 106A). For example, after handover or SN change to the base station 106B, the UE 102 can use a radio bearer (e.g., a DRB or an SRB) that at different times terminates at the base station 106B. The UE 102 can apply one or more security keys when communicating on the radio bearer, in the uplink (UL) direction (i.e., from the UE 102 to a base station) and/or downlink (DL) direction (i.e., from a base station to the UE 102). In non-MBS operation, the UE 102 transmits data via the radio bearer on (i.e., within) an uplink BWP of a cell to the base station and/or receives data via the radio bearer on a DL BWP of the cell from the base station. The UL BWP can be an initial UL BWP or a dedicated UL BWP, and the DL BWP can be an initial DL BWP or a dedicated DL BWP. The UE 102 can receive paging, system information, public warning message(s), or a random access response on the DL BWP. In such non-MBS operation, the UE 102 can be in a connected state. Alternatively, the UE 102 can be in an idle or inactive state if the UE 102 supports small data transmission in the idle or inactive state.

In MBS operation, the UE 102 can use a radio bearer (e.g., a DRB or an MRB) that at different times terminates at an MN (e.g., the base station 104) or an SN (e.g., the base station 106A). For example, after handover or SN change to the base station 106B, the UE 102 can use a radio bearer (e.g., a DRB or an MRB) that at different times terminates at the base station 106B which can be an MN or SN. The base station can utilize the radio bearer to transmit application-level messages, such as security keys, to the UE 102. In some implementations, the base station (e.g., the MN or SN) can transmit MBS data over dedicated radio resources (i.e., the radio resources dedicated to the UE 102) to the UE 102 (e.g., via the DRB or MRB). In such implementations, the base station can apply one or more security keys to protect integrity of MBS data and/or encrypt MBS data and transmits the encrypted and/or integrity protected MBS data over the dedicated radio resources to the UE 102. Correspondingly, the UE 102 can apply the one or more security keys to decrypt MBS data and/or check integrity of the MBS data when receiving the MBS data on the radio bearer, in the downlink (from a base station to the UE 102) direction. In other implementations, the base station (e.g., the MN or SN) can transmit MBS data over common radio resources (i.e., the radio resources common to the UE 102 and other UE(s) such as common frequency resources (CFR)) or a DL BWP of a cell from the base station to the UE 102 (e.g., via the DRB or MRB). The DL BWP can be an initial DL BWP, a dedicated DL BWP, or an MBS DL BWP (i.e., a DL BWP specific for MBS or not for unicast). In such implementations, the base station can refrain from applying a security key to MBS data and transmit the MBS data on the radio bearer. Correspondingly, the UE 102 can omit applying a security key to MBS data received on the radio bearer. The UE 102 can apply an application-level security key, received from the CN 110 or an MBS server, to MBS data received on the radio bearer.

The base station 104 includes processing hardware 130, which can include one or more general-purpose processors (e.g., central processing units (CPUs)) and a computer-readable memory storing machine-readable instructions executable on the one or more general-purpose processor(s), and/or special-purpose processing units. The processing hardware 130 in the example implementation in FIG. 1A includes a base station MBS controller 132 that is configured to manage or control transmission of MBS information received from the CN 110 or an edge server. For example, the base station MBS controller 132 can be configured to support Radio Resource Control (RRC) configurations, procedures and messaging associated with MBS procedures, and/or to support the necessary operations, as discussed below. The processing hardware 130 can include a base station non-MBS controller 134 configured to manage or control one or more RRC configurations and/or RRC procedures when the base station 104 operates as an MN or SN during a non-MBS operation.

The base station 106A includes processing hardware 140, which can include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes a base station MBS controller 142 that is configured to manage or control transmission of MBS information received from the CN 110 or an edge server. For example, the base station MBS controller 142 can be configured to support RRC configurations, procedures and messaging associated with MBS procedures, and/or to support the necessary operations, as discussed below. The processing hardware 140 can include a base station non-MBS controller 144 configured to manage or control one or more RRC configurations and/or RRC procedures when the base station 106A operates as an MN or SN during a non-MBS operation. While not shown in FIG. 1A, the base station 106B can include processing hardware similar to the processing hardware 130 of the base station 104 or the processing hardware 140 of the base station 106A.

The UE 102 includes processing hardware 150, which can include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes a UE MBS controller 152 that is configured to manage or control reception of MBS information. For example, the UE MBS controller 152 can be configured to support RRC configurations, procedures and messaging associated with MBS procedures, and/or to support the necessary operations, as discussed below. The processing hardware 150 can include a UE non-MBS controller 154 configured to manage or control one or more RRC configurations and/or RRC procedures in accordance with any of the implementations discussed below, when the UE 102 communicates with an MN and/or an SN during a non-MBS operation.

The CN 110 can be an evolved packet core (EPC) 111 or a fifth-generation core (5GC) 160, both of which are depicted in FIG. 1A. The base station 104 can be an eNB supporting an SI interface for communicating with the EPC 111, an ng-eNB supporting an NG interface for communicating with the 5GC 160, or a gNB that supports an NR radio interface as well as an NG interface for communicating with the 5GC 160. The base station 106A can be an EUTRA-NR DC (EN-DC) gNB (en-gNB) with an SI interface to the EPC 111, an en-gNB that does not connect to the EPC 111, a gNB that supports the NR radio interface and an NG interface to the 5GC 160, or a ng-eNB that supports an EUTRA radio interface and an NG interface to the 5GC 160. To directly exchange messages with each other during the scenarios discussed below, the base stations 104, 106A, and 106B can support an X2 or Xn interface.

Among other components, the EPC 111 can include a Serving Gateway (SGW) 112, a Mobility Management Entity (MME) 114, and a Packet Data Network Gateway (PGW) 116. The SGW 112 is generally configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management (AMF) 164, and/or Session Management Function (SMF) 166. The UPF 162 is generally configured to transfer user-plane packets related to audio calls, video calls, Internet traffic, etc., the AMF 164 is configured to manage authentication, registration, paging, and other related functions, and the SMF 166 is configured to manage PDU sessions. The UPF 162, AMF 164 and/or the SMF 166 can be configured to support MBS. For example, the SMF 166 can be configured to manage or control MBS transport, configure the UPF 162 and/or RAN 105 for MBS flows, and/or manage or configure MBS session(s) or PDU Session(s) for MBS for UE 102. The UPF 162 is configured to transfer MBS data packets to audio, video, Internet traffic, etc. to the RAN 105. The UPF 162 and/or SMF 166 can be configured for both unicast service and MBS, or for MBS only.

Generally, the wireless communication network 100 can include any suitable number of base stations supporting NR cells and/or EUTRA cells. More particularly, the EPC 111 or the 5GC 160 can be connected to any suitable number of base stations supporting NR cells and/or EUTRA cells. Although the examples below refer specifically to specific CN types (EPC, 5GC) and RAT types (5G NR and EUTRA), in general the techniques of this disclosure can also apply to other suitable radio access and/or core network technologies such as sixth generation (6G) radio access and/or 6G core network or 5G NR-6G DC, for example.

In different configurations or scenarios of the wireless communication system 100, the base station 104 can operate as an MeNB, an Mng-eNB, or an MgNB, the base station 106B can operate as an MeNB, an Mng-eNB, an MgNB, an SgNB, or an Sng-eNB, and the base station 106A can operate as an SgNB or an Sng-eNB. The UE 102 can communicate with the base station 104 and the base station 106A or 106B via the same radio access technology (RAT), such as EUTRA or NR, or via different RATs.

When the base station 104 is an MeNB and the base station 106A is an SgNB, the UE 102 can be in EN-DC with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is an Sng-eNB, the UE 102 can be in NR-EUTRA DC (NE-DC) with the MgNB 104 and the Sng-eNB 106A.

FIG. 1B depicts an example, distributed implementation of any one or more of the base stations 104, 106A, 106B. In this implementation, the base station 104, 106A, or 106B includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include the processing hardware 130 or 140 of FIG. 1A.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a medium access control (MAC) controller configured to manage or control one or more MAC operations or procedures (e.g., a random access procedure), and a radio link control (RLC) controller configured to manage or control one or more RLC operations or procedures when the base station (e.g., base station 106A) operates as an MN or an SN. The processing hardware can also include a physical layer controller configured to manage or control one or more physical layer operations or procedures.

In some implementations, the CU 172 can include a logical node CU-CP 172A that hosts the control plane part of the Packet Data Convergence Protocol (PDCP) protocol of the CU 172 and/or radio resource control (RRC) protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit the non-MBS control information and MBS control information, and the CU-UP 172B can transmit the non-MBS data packets and MBS data packets, as described herein.

The CU-CP 172A can be connected to multiple CU-UP 172B through the E1 interface. The CU-CP 172A selects the appropriate CU-UP 172B for the requested services for the UE 102. In some implementations, a single CU-UP 172B can be connected to multiple CU-CP 172A through the E1 interface. The CU-CP 172A can be connected to one or more DU 174s through an F1-C interface. The CU-UP 172B can be connected to one or more DU 174 through the F1-U interface under the control of the same CU-CP 172A. In some implementations, one DU 174 can be connected to multiple CU-UP 172B under the control of the same CU-CP 172A. In such implementations, the connectivity between a CU-UP 172B and a DU 174 is established by the CU-CP 172A using Bearer Context Management functions.

FIG. 2 illustrates, in a simplified manner, an example protocol stack 200 according to which the UE 102 can communicate with an eNB/ng-eNB or a gNB (e.g., one or more of the base stations 104, 106A, 106B).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to the EUTRA PDCP sublayer 208 and, in some cases, to the NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides RLC channels to the NR PDCP sublayer 210. The UE 102, in some implementations, supports both the EUTRA and the NR stack as shown in FIG. 2, to support handover between EUTRA and NR base stations and/or to support DC over EUTRA and NR interfaces. Further, as illustrated in FIG. 2, the UE 102 can support layering of NR PDCP 210 over EUTRA RLC 206A, and an SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets”. The packets can be MBS packets or non-MBS packets. For example, the MBS packets include MBS data packets including application content for an MBS service (e.g., IPv4/IPv6 multicast delivery, IPTV, software delivery over wireless, group communications, IoT applications, V2X applications, and/or emergency messages related to public safety). In another example, the MBS packets include application control information for the MBS service.

On a control plane, the EUTRA PDCP sublayer 208 and the NR PDCP sublayer 210 can provide SRBs to exchange RRC messages or non-access-stratum (NAS) messages, for example. On a user plane, the EUTRA PDCP sublayer 208 and the NR PDCP sublayer 210 can provide DRBs to support data exchange. Data exchanged on the NR PDCP sublayer 210 can be SDAP PDUs, Internet Protocol (IP) packets or Ethernet packets.

In scenarios where the UE 102 operates in EN-DC with the base station 104 operating as an MeNB and the base station 106A operating as an SgNB, the wireless communication system 100 can provide the UE 102 with an MN-terminated bearer that uses EUTRA PDCP sublayer 208, or an MN-terminated bearer that uses NR PDCP sublayer 210. The wireless communication system 100 in various scenarios can also provide the UE 102 with an SN-terminated bearer, which uses only the NR PDCP sublayer 210. The MN-terminated bearer can be an MCG bearer, a split bearer, or an MN-terminated SCG bearer. The SN-terminated bearer can be an SCG bearer, a split bearer, or an SN-terminated MCG bearer. The MN-terminated bearer can be an SRB (e.g., SRB1 or SRB2) or a DRB. The SN-terminated bearer can be an SRB or a DRB.

In some implementations, a base station (e.g., base station 104, 106A or 106B) broadcasts MBS data packets via one or more MBS radio bearers (MRB(s)), and in turn the UE 102 receives the MBS data packets via the MRB(s). The base station can include configuration(s) of the MRB(s) in multicast configuration parameters (which can also be referred to as MBS configuration parameters) described below. In some implementations, the base station broadcasts the MBS data packets via RLC sublayer 206, MAC sublayer 204, and PHY sublayer 202, and correspondingly, the UE 102 uses PHY sublayer 202, MAC sublayer 204, and RLC sublayer 206 to receive the MBS data packets. In such implementations, the base station and the UE 102 may not use PDCP sublayer 208 and a SDAP sublayer 212 to communicate the MBS data packets. In other implementations, the base station transmits the MBS data packets via PDCP sublayer 208, RLC sublayer 206, MAC sublayer 204, and PHY sublayer 202, and correspondingly, the UE 102 uses PHY sublayer 202, MAC sublayer 204, RLC sublayer 206 and PDCP sublayer 208 to receive the MBS data packets. In such implementations, the base station and the UE 102 may not use a SDAP sublayer 212 to communicate the MBS data packets. In yet other implementations, the base station transmits the MBS data packets via the SDAP sublayer 212, PDCP sublayer 208, RLC sublayer 206, MAC sublayer 204 and PHY sublayer 202, and correspondingly, the UE 102 uses PHY sublayer 202, MAC sublayer 204, RLC sublayer 206, PDCP sublayer 208, and the SDAP sublayer 212 to receive the MBS data packets.

To simplify the following description, the UE 102 represents the UE 102A and the UE 102B, unless explicitly indicated otherwise.

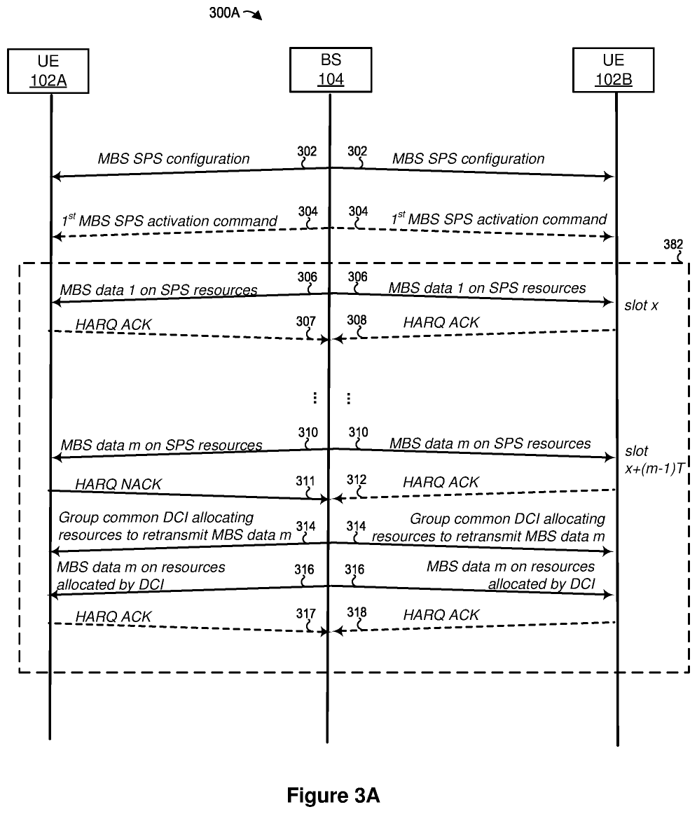

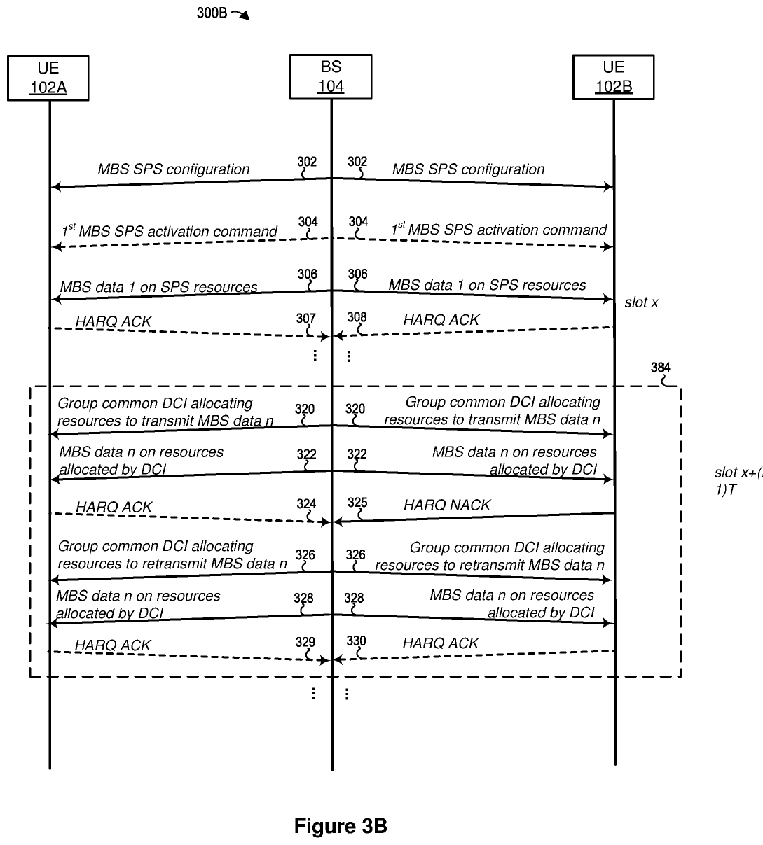

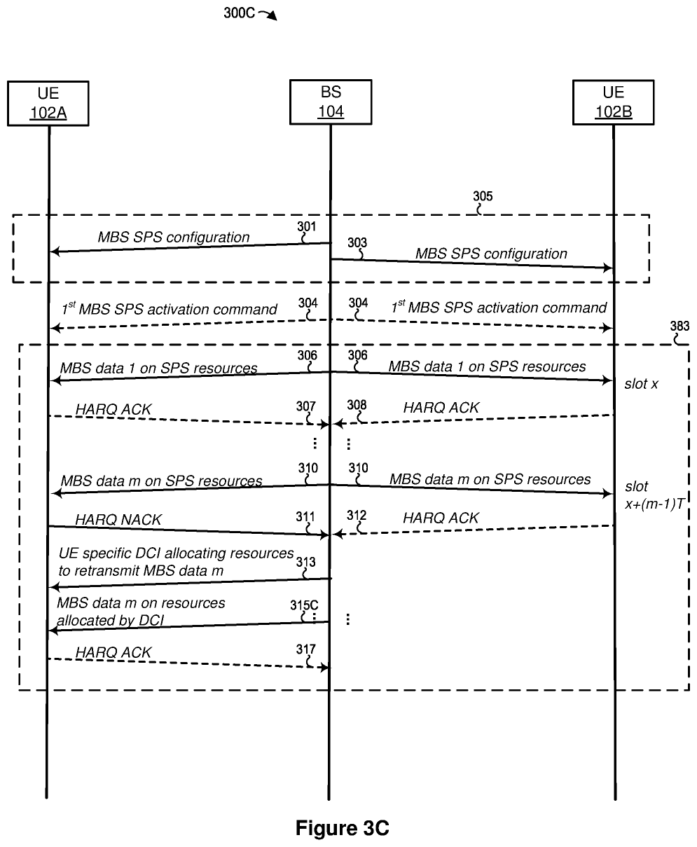

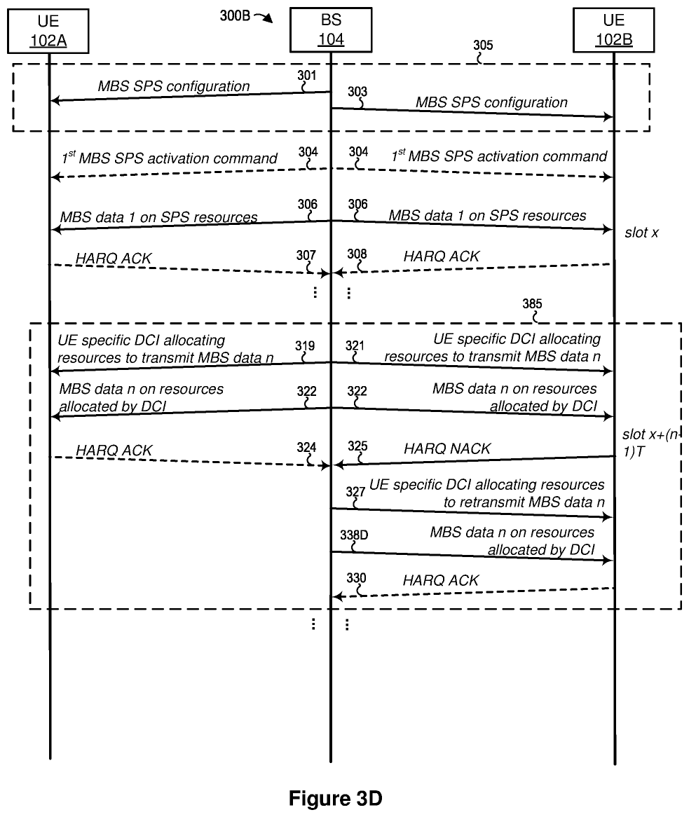

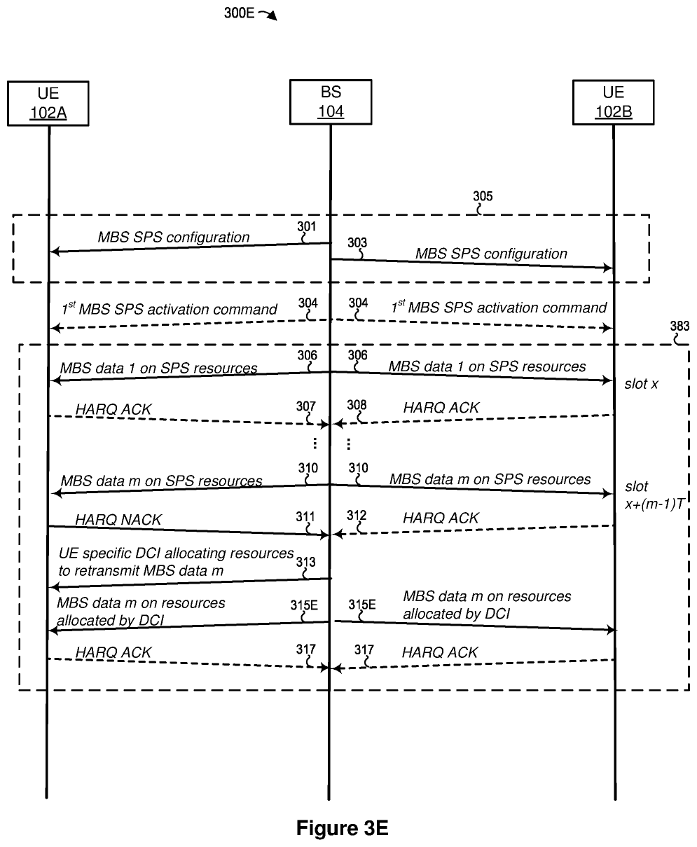

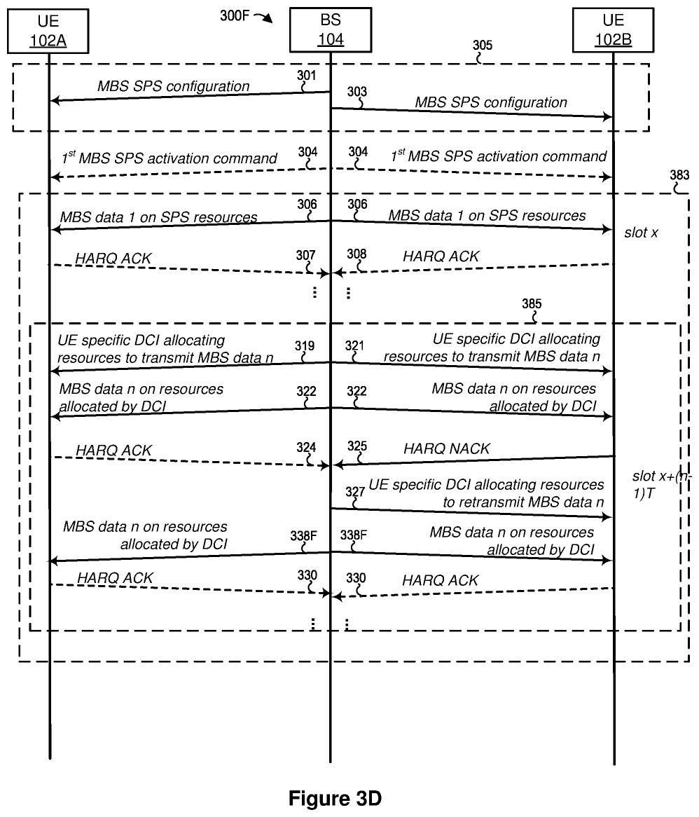

FIGS. 3A-3F are messaging diagrams of example scenarios in which one or more UEs and a base station of the RAN implement the techniques of this disclosure for managing MBS on SPS and/or dynamic radio resources. The radio resources can consist of symbols, slots, frequency resources (e.g., PRBs or resource elements) and/or a particular code (e.g., scrambling code or orthogonal code). Generally speaking, events in FIGS. 3A-3F that are similar are labeled with similar reference numbers, with differences discussed below where appropriate. With the exception of the differences shown in the figures and discussed below, any on the alternative implementations discussed with respect to a particular event (e.g., for messaging and processing) may apply to events labeled with similar reference numbers in other figures.

Referring first to a scenario 300A illustrated in FIG. 3A, a base station 104 initially transmits (i.e., multicasts or broadcasts) 302 an MBS SPS configuration (i.e., an SPS configuration for MBS) to a UE 102A and a UE 102B. In some implementations, the base station 104 can broadcast 302 a system information block (SIB) including the MBS SPS configuration via the cell 124. In other implementations, the base station 104 can broadcast or multicast 302 an MBS-specific message including the MBS SPS configuration via the cell 124. In some scenarios, the UE 102A and the UE 102B can receive the same instance of the SIB or MBS-specific message. In other scenarios, the UE 102A and the UE 102B can receive difference instances of the SIB or MBS-specific message. For example, the MBS-specific message can be a Multimedia Broadcast Multicast Service (MBMS) point-to-multipoint Control Channel (MCCH) message. In some implementations, the UE 102 (i.e., the UE 102A and/or 102B) operating in an idle state or an inactive state (e.g., RRC_IDLE state, RRC_INACTIVE state) receives 302 the MBS SPS configuration from the base station 104. Alternatively, the UE 102 operating in a connected state (e.g., RRC_CONNECTED state) receives 302 the MBS SPS configuration from the base station 104. In the MBS SPS configuration, the base station 104 can include a periodicity (e.g., T) where SPS radio resources occur, for example. In the MBS SPS configuration, the base station 104 can also include a physical uplink control channel (PUCCH) configuration configuring radio resources (i.e., PUCCH resources) for the UE 102 to transmit hybrid automatic repeat request (HARQ) acknowledgements (ACKs) or HARQ negative ACKs (NACKs) or to only transmit HARQ NACKs. The base station 104 can additionally include, in the MBS SPS configuration, a physical downlink shared channel (PDSCH) configuration including configuration parameters for receiving PDSCH transmissions including MBS data on SPS resources.

After transmitting 302 the MBS SPS configuration, the base station 104 can transmit 304 one or more MBS SPS activation commands to the UE 102 to enable the UE 102 to start receiving MBS data periodically. In some implementations, the MBS SPS activation command(s) can be DCI(s). If each of the DCI(s) is different, the base station 104 can obtain a particular CRC from each of the DCI(s) and scramble the CRC with a first group-common RNTI. Otherwise, the base station 104 can obtain a CRC from the DCI(s) and scramble the CRC with the first group-common RNTI. Then the base station 104 transmits the DCI(s) and scrambled CRC(s) on PDCCH(s) to the UE 102.

After receiving one of the MBS SPS activation command(s), the UE 102 starts receiving a HARQ new transmission including MBS data on SPS resources at slot x. The base station 104 can send 304 the MBS SPS activation command(s) by unicasting the MBS SPS activation command(s) separately to each of the UE 102A and the UE 102B, respectively, or by broadcasting or multicasting the MBS SPS activation command(s) to both the UE 102A and the UE 102B.

As yet another alternative, the base station 104 does not send the MBS SPS activation command(s). In some implementations, the base station 104 transmits an MBS SPS configuration and an activation indication in the SIB and the MCCH-specific message. In some implementations, the activation indication is included in the MBS SPS configuration. In such implementations, the activation indication may be an information element (IE), field, or flag. Alternatively, in such implementations, the activation indication may not be an explicit indication. Rather, reception of the MBS SPS configuration (i.e., an SPS configuration that is for receiving MBS data) implicitly instructs the UE 102A and/or the UE 102B to activate receiving MBS data in accordance with the first MBS SPS configuration.

After transmitting the MBS SPS activation command(s), the base station 104 generates a HARQ new transmission 1 from a MAC PDU including MBS data 1 and transmits 306 the HARQ new transmission 1 on SPS resources at slot x, . . . , generates a HARQ new transmission m from a MAC PDU including MBS data m and transmits 310 the HARQ new transmission m on SPS resources at slot x+(m−1)T. The value “m” can be an integer larger than 2. The base station 104 can configure the SPS resources in the MBS SPS activation command(s) and/or the MBS SPS configuration. In some implementations, the SPS resources include frequency resources such as physical resource blocks (PRBs). For example, the base station 104 can include a frequency domain resource assignment field in the MBS SPS activation command or the MBS SPS configuration to configure the PRBs. The base station 104 can include a time domain resource assignment field to configure the time offset in the MBS SPS activation command or the MBS SPS configuration. The base station 104 can also include, in the MBS SPS activation command or the MBS SPS configuration, configuration parameters of a modulation and coding scheme (MCS), a new data indicator (e.g., value 0), an SPS index associated with the MBS SPS configuration, a redundancy version, a PUCCH resource indicator, a transmit power control (TPC) command (e.g., for scheduled PUCCH), a virtual resource block (VRB)-to-PRB mapping, an identifier for DCI formats, and/or PDSCH-to-HARQ feedback timing indicator.

After the UE 102 receives one of the MBS SPS activation command(s), the UE 102 (starts to) receive 306 the HARQ new transmission 1 on SPS resources at slot x, . . . , and receives 310 the HARQ new transmission m on SPS resources at slot x+(m−1)T. In some implementations, the UE 102A can send 307 a HARQ ACK to the base station 104 if the UE 102A successfully decodes a transport block from the HARQ new transmission 1 (e.g., obtains a transport block (i.e., MAC PDU) from the HARQ new transmission 1). Similarly, the UE 102B can send 308 a HARQ ACK to the base station 104 if the UE 102B successfully decodes the HARQ new transmission m (e.g., obtains a transport block from the HARQ new transmission m).

In some implementations, the UE 102A sends 311 a HARQ NACK to the base station 104 because the UE 102A fails to decode the HARQ new transmission 1 (e.g., fails to obtain a transport block (i.e., a MAC PDU) from the HARQ new transmission 1). The UE 102B can send 312 a HARQ ACK to the base station 104 if the UE 102B successfully decodes HARQ new transmission 1 (e.g., obtains a transport block from the HARQ new transmission m). In response to the HARQ NACK 311, the base station 104 generates a first HARQ retransmission from the MAC PDU including the MBS data m, generates a first group-common DCI allocating radio resources for the first HARQ retransmission, generates a CRC from the first group-common DCI, scrambles the CRC with a second group-common RNTI, and transmits (i.e., multicast/broadcast) 314 the first group-common DCI and the scrambled CRC on a PDCCH to the UE 102A and the UE 102B.

After transmitting 314 the first group-common DCI and scrambled CRC, the base station 104 transmits (i.e., multicast/broadcast) 316 the first HARQ retransmission on the radio resources configured by the first group-common DCI. In some implementations, the base station 104 can scramble the first HARQ retransmission with a first scrambling sequence and then transmit 316 the (scrambled) first HARQ retransmission. The base station 104 and UE 102 can derive the first scrambling sequence from a cell identity of cell 124 and/or the second group-common RNTI. The UE 102 descrambles the (scrambled) HARQ new transmission n by using the first scrambling sequence.

In some implementations, the base station 104 can include a time domain resource assignment field to configure a time offset in the first group-common DCI. In other implementations, the base station 104 can also include, in the first group-common DCI, configuration parameters of a MCS, a new data indicator (e.g., value 0 or 1), a redundancy version, a PUCCH resource indicator, a transmit power control (TPC) command (e.g., for scheduled PUCCH), a virtual resource block (VRB)-to-PRB mapping, an identifier for DCI formats, and/or PDSCH-to-HARQ feedback timing indicator.

After the UE 102 receives the first group-common DCI and the scrambled CRC on the PDCCH, the UE 102 verifies the scrambled CRC by using the second group-common RNTI and the first group-common DCI. In some implementations, the UE 102 descrambles the scrambled CRC to obtain a descrambled CRC by using the second group-common RNTI. Then, the UE 102 obtains a computed CRC from the first group-common DCI. If the computed CRC is identical to the descrambled CRC, the UE 102 determines the first group-common DCI is valid. Otherwise, the UE 102 determines the first group-common DCI is invalid. In other implementations, the UE 102 obtains a computed CRC from the first group-common DCI, and scrambles the computed CRC to obtain a scrambled, computed CRC by using the second group-common RNTI. If the scrambled, computed CRC is identical to the scrambled CRC received on the PDCCH, the UE 102 determines the first group-common DCI is valid. Otherwise, the UE 102 determines the first group-common DCI is invalid. If the first group-common DCI is valid, the UE 102 attempts to receive 316 the first HARQ retransmission in accordance with the first group-common DCI. In some implementations, the UE 102A can send 317 a HARQ ACK to the base station 104 if the UE 102A successfully decodes the first HARQ retransmission (e.g., obtains a MAC PDU from the first HARQ retransmission or from a combination of the HARQ new transmission m and the first HARQ retransmission). The UE 102B can also send 318 a HARQ ACK to the base station 104 if the UE 102B successfully decodes the first HARQ retransmission (e.g., obtains a MAC PDU from the first HARQ retransmission or from a combination of the HARQ new transmission m and the first HARQ retransmission). Alternatively, the UE 102B refrains from sending a HARQ ACK to the base station 104 if the UE 102B successfully decodes the first HARQ retransmission (e.g., obtains a MAC PDU from the first HARQ retransmission or from a combination of the HARQ new transmission m and the first HARQ retransmission). As yet another alternative, the UE 102B refrains from receiving the first group-common DCI or the first HARQ retransmission if the UE 102B successfully decodes the HARQ new transmission m.

The events 306, 306, 310, 312, 314, 316, 317, and 318 collectively make up an MBS transmission procedure 382, in which a base station uses SPS resources for transmission of a certain data (e.g., event 310) and dynamic scheduling (e.g., event 314) for a retransmission of that data (e.g., event 316).

After the completing 314-317 the retransmission of the MBS data m, the base station 104 can continue transmitting the MBS subsequent data (e.g., transmission m+1, m+2, . . . ) using the SPS resources.

FIG. 3B illustrates a scenario 300B in which the base station 104 uses dynamic scheduling to augment SPS due to certain properties of the upcoming transmission (e.g., the size of a MAC PDU exceeding the capacity of the regularly scheduled SPS resource) rather than detecting that one or more UEs failed to receive an MBS transmission over the SPS resources.

In this scenario, after transmitting 306 the MBS data 1, the base station 104 generates a HARQ new transmission n from a MAC PDU including the MBS data n, generates a group-common DCI allocating radio resources for the HARQ new transmission n, generates a CRC from a group-common DCI, scrambles the CRC with a group-common RNTI, and transmits (i.e., multicast/broadcast) 320 the group-common DCI and the scrambled CRC on a PDCCH to the UE 102A and the UE 102B. The base station 104 in some cases uses a second group-common DCI and a second group-common RNTI different from the first group-common DCI and the group-common RNTI, respectively, used for the retransmission of the data m in the scenario of FIG. 3A. The value “n” can be a positive integer larger or smaller than the value “m”. The base station 104 can include similar fields or similar configuration parameters with same or different values in the second group-common DCI, similar to the first group-common DCI.

After transmitting 320 the second group-common DCI and scrambled CRC, the base station 104 transmits (i.e., multicast/broadcast) 322 the HARQ new transmission n on the radio resources configured by the second group-common DCI. After the UE 102 receives the second group-common DCI and the scrambled CRC on the PDCCH, the UE 102 verifies the scrambled CRC by using the third group-common RNTI and the second group-common DCI. In some implementations, the UE 102 descrambles the scrambled CRC to obtain a descrambled CRC by using the third group-common RNTI. Then, the UE 102 obtains a computed CRC from the second group-common DCI. If the computed CRC is identical to the descrambled CRC, the UE 102 determines the second group-common DCI is valid. Otherwise, the UE 102 determines the second group-common DCI is invalid. In other implementations, the UE 102 obtains a computed CRC from the second group-common DCI, and scrambles the computed CRC to obtain a scrambled, computed CRC by using the third group-common RNTI. If the scrambled, computed CRC is identical to the scrambled CRC received on the PDCCH, the UE 102 determines the second group-common DCI is valid. Otherwise, the UE 102 determines the second group-common DCI is invalid. If the second group-common DCI is valid, the UE 102 attempts to receive 316 the HARQ new transmission n in accordance with the second group-common DCI.

In some implementations, the UE 102A can send 324 a HARQ ACK to the base station 104 if the UE 102A successfully decodes the HARQ new transmission n (e.g., obtains a MAC PDU from the HARQ new transmission n). The UE 102B sends 325 a HARQ NACK to the base station 104 because the UE 102B fails to decode the HARQ new transmission n (e.g., fails to obtain a transport block (e.g., a MAC PDU) from the HARQ new transmission n).

In some implementations, the base station 104 can scramble the HARQ new transmission n with a second scrambling sequence and then transmit 322 the (scrambled) HARQ new transmission n. The UE 102 and base station 104 can derive the second scrambling sequence from the cell identity of cell 124 and/or the third group-common RNTI. The UE 102 descrambles the (scrambled) HARQ new transmission n by using the second scrambling sequence.

In response to the HARQ NACK 325, the base station 104 generates a second HARQ retransmission from the MAC PDU including the MBS data n, generates another (third) group-common DCI allocating radio resources for the second HARQ retransmission, generates a CRC from the third group-common DCI, scrambles the CRC with the third group-common RNTI, and transmits (i.e., multicast/broadcast) 326 the third group-common DCI and the scrambled CRC on a PDCCH to the UE 102A and the UE 102B. The base station 104 can include similar fields or similar configuration parameters with same or different values in the third group-common DCI, similar to the first group-common DCI.

After transmitting 326 the third group-common DCI and scrambled CRC, the base station 104 transmits (i.e., multicast/broadcast) 328 the second HARQ retransmission on the radio resources configured by the third group-common DCI. After the UE 102 receives the third group-common DCI and the scrambled CRC on the PDCCH, the UE 102 verifies the scrambled CRC by using the third group-common RNTI and the third group-common DCI. In some implementations, the UE 102 descrambles the scrambled CRC to obtain a descrambled CRC by using the third group-common RNTI. Then, the UE 102 obtains a computed CRC from the third group-common DCI. If the computed CRC is identical to the descrambled CRC, the UE 102 determines the third group-common DCI is valid. Otherwise, the UE 102 determines the third group-common DCI is invalid. In other implementations, the UE 102 obtains a computed CRC from the third group-common DCI, and scrambles the computed CRC to obtain a scrambled, computed CRC by using the third group-common RNTI. If the scrambled, computed CRC is identical to the scrambled CRC received on the PDCCH, the UE 102 determines the third group-common DCI is valid. Otherwise, the UE 102 determines the third group-common DCI is invalid.

If the third group-common DCI is valid, the UE 102 attempts to receive 328 the second HARQ retransmission in accordance with the third group-common DCI. In some implementations, the UE 102A can send 329 a HARQ ACK to the base station 104 if the UE 102A successfully decodes the second HARQ retransmission (e.g., obtains a MAC PDU from the second HARQ retransmission or from a combination of the HARQ new transmission n and the second HARQ retransmission). Similarly, the UE 102B can send 330 a HARQ ACK to the base station 104 if the UE 102B successfully decodes the second HARQ retransmission (e.g., obtains a MAC PDU from the second HARQ retransmission or from a combination of the HARQ new transmission n and the second HARQ retransmission). Alternatively, the UE 102A refrains from sending a HARQ ACK to the base station 104 if the UE 102A successfully decodes the second HARQ retransmission (e.g., obtains a MAC PDU from the second HARQ retransmission or from a combination of the HARQ new transmission n and the second HARQ retransmission). As yet another alternatively, the UE 102A refrains from receiving the third group-common DCI or the second HARQ retransmission if the UE 102A successfully decodes the HARQ new transmission n.

In some implementations, the base station 104 can scramble the second HARQ retransmission with a third scrambling sequence and then transmit 328 the (scrambled) second HARQ retransmission. The base station 104 and UE 102 can derive the third scrambling sequence from the cell identity of cell 124 and/or the third group-common RNTI. The UE 102 descrambles the (scrambled) HARQ new transmission n by using the third scrambling sequence.

In some implementations, the base station 104 can transmit 322 the HARQ new transmission n at slot x+(n−1)T. In the second group-common DCI, the base station 104 can indicate the UE 102 to receive 322 the HARQ new transmission n at slot x+(n−1)T. The UE 102 receives 322 the HARQ new transmission n at slot x+(n−1)T in accordance with the second group-common DCI. The UE 102 receives 322 the HARQ new transmission n at slot x+(n−1)T on the radio resources configured by the second group-common DCI instead of on the SPS resources. In other implementations, the base station 104 can transmit 322 the HARQ new transmission n at slot k other than slot x+(n−1)T. The value “k” is a positive integer smaller than the value “m”. In such cases, the base station 104 can indicate the UE 102 to receive 322 the HARQ new transmission n at slot k in the second group-common DCI. The UE 102 receives 322 the HARQ new transmission n at slot k in accordance with the second group-common DCI. The UE 102 receives 322 the HARQ new transmission n at slot k on the radio resources configured by the second group-common DCI.

To distinguish HARQ feedbacks (e.g., HACK ACKs or HARQ NACKs) transmitted by different UEs (including the UE 102A, the UE 102B, and optionally other UE(s)), the base station 104 can configure each of the UEs to use particular (or different) radio resources (i.e., PUCCH resources) to transmit HARQ feedbacks for the HARQ new transmissions and HARQ retransmissions described above. For example, the base station 104 can send a particular message to each of the UEs to configure particular radio resources to transmit a HARQ feedback. Each of the UEs can transmit a particular response message to the base station 104 in response to the particular message. For example, the particular message and particular response message can be a dedicated RRC message (e.g., a RRC reconfiguration message) and a dedicated RRC response message (e.g., RRC reconfiguration complete message), respectively. In such cases, the base station 104 can transmit 314 the first group-common DCI and 316 the first HARQ retransmission in response to not receiving a HARQ feedback from the UE 102A at event 311. Likewise, the base station 104 can transmit 326 the third group-common DCI and 328 the second HARQ retransmission in response to not receiving a HARQ feedback from the UE 102B at event 325.

For example, the UE 102A can transmit the HARQ ACK 307 on first radio resources, and the UE 102B can transmit the HARQ ACK 308 on second radio resources, respectively. The first and second radio resources include different symbols, slots, frequency resources (e.g., PRBs or resource elements) and/or orthogonal codes. In another example, the UE 102A can transmit the HARQ NACK 311 on third radio resources, and the UE 102B can transmit the HARQ ACK 312 on fourth radio resources, respectively. The third and fourth radio resources include different symbols, slots, frequency resources (e.g., PRBs or resource elements) and/or orthogonal codes. In yet another example, the UE 102A can transmit the HARQ ACK 317 on fifth radio resources, and the UE 102B can transmit the HARQ ACK 318 on sixth radio resources, respectively. The fifth and sixth radio resources include different symbols, slots, frequency resources (e.g., PRBs or resource elements) and/or orthogonal codes. In yet another example, the UE 102A can transmit the HARQ ACK 324 on seventh radio resources, and the UE 102B can transmit the HARQ NACK 325 on eighth radio resources, respectively. The seventh and eighth radio resources include different symbols, slots, frequency resources (e.g., PRBs or resource elements) and/or orthogonal codes. In yet another example, the UE 102A can transmit the HARQ ACK 329 on ninth radio resources, and the UE 102B can transmit the HARQ ACK 3330 on tenth radio resources, respectively. The ninth and tenth radio resources include different symbols, slots, frequency resources (e.g., PRBs or resource elements) and/or orthogonal codes.

In some alternative implementations, the base station 104 can configure each of the UEs (e.g., the UE 102A and the UE 102B) to use particular radio resources to only transmit the HARQ NACKs for the HARQ new transmissions and HARQ retransmissions described above. For example, the base station 104 can send a particular message to each of the UEs to configure particular radio resources to transmit HARQ NACKs. Each of the UEs can transmit a particular response message to the base station 104 in response to the particular message. For example, the particular message and particular response message can be a dedicated RRC message (e.g., a RRC reconfiguration message) and a dedicated RRC response message (e.g., RRC reconfiguration complete message), respectively. The radio resources for HARQ NACKs can consist of symbols, slots, frequency resources (e.g., PRBs or resource elements) and/or orthogonal codes. In such implementations, a particular UE (e.g., the UE 102) does not transmit a HARQ ACK if the UE successfully decodes a HARQ transmission (i.e., the HARQ new transmission, the HARQ retransmission and/or combination of the HARQ new transmission and the HARQ retransmission). Otherwise, the UE can transmit a HARQ NACK on the particular radio resources to the base station 104.

In other alternative implementations, the base station 104 can configure the UEs to use the same radio resources to only transmit HARQ NACKs for the HARQ new transmissions and HARQ retransmissions described above. For example, the base station 104 can send a particular message to each of the UEs to configure particular radio resources to transmit HARQ NACKs. Each of the UEs can transmit a particular response message to the base station 104 in response to the particular message. For example, the particular message and particular response message can be a dedicated RRC message (e.g., a RRC reconfiguration message) and a dedicated RRC response message (e.g., RRC reconfiguration complete message), respectively. In another example, the base station 104 can multicast or broadcast the UEs a SIB or MCCH-specific message to configure the same radio resources to transmit HARQ NACKs. In such implementations, a particular UE (e.g., the UE 102) does not transmit a HARQ ACK if the UE successfully decodes a HARQ transmission (i.e., the HARQ new transmission, the HARQ retransmission and/or combination of the HARQ new transmission and the HARQ retransmission). Otherwise, the UE 102 can transmit a HARQ NACK on the same radio resources to the base station 104.

The events 320, 322, 324, 325, 326, 327, 329, and 330 can be collectively referred to as an MBS non-SPS data transmission procedure 384, or an MBS dynamic transmission procedure. It is noted that the base station 104 can perform the procedure 384 along with the procedure 382 during a certain MBS session.

Referring to both FIG. 3A and FIG. 3B, the MBS data can include at least one MBS data packet(s) of at least one MBS. In other implementations, the MBS data can include a segment of an MBS data packet.

In some implementations, the base station 104 scrambles the HARQ new transmissions 1, . . . , m with a particular scrambling sequence and transmits the scrambled HARQ new transmissions at events 306, 310. The base station 104 derives the particular scrambling sequence from the cell identity of cell 124 and/or the first group-common RNTI.

In some implementations, the base station 104 transmits 320 the first group-common DCI because interference occurs on the SPS resources or the SPS resources cannot accommodate (the MAC PDU including) the MBS data n or accommodate the HARQ new transmission n. In other implementations, the amount of the MBS data n is not much to fully use the SPS resources. In such cases, the BS allocates radio resources fewer than the SPS resources to transmit (the MAC PDU including) the MBS data n or the HARQ new transmission n in order to save radio resources, in the first group-common DCI.

In some implementations, the base station 104 can include the first, second and/or third group-common RNTIs in the MBS SPS configuration, the SIB and/or the MCCH-specific message. In some implementations, the first and second group-common RNTIs can be the same RNTI or the same value, and the third RNTI is different from the first/second group-common RNTI. For example, the first/second group-common RNTI can be an MBS configured scheduling RNTI (CS-RNTI) or a group CS-RNTI, and the third group-common RNTI can be an MBS cell RNTI (C-RNTI), a group C-RNTI or a group RNTI (G-RNTI). In other implementations, the first, second and third group-common RNTIs are different RNTIs.

In some implementations, the base station 104 can include a first New Data Indicator (NDI) value in the DCI(s) which are the MBS SPS activation command(s). For example, the first NDI value can be a first default value. In some implementations, the base station 104 includes a second NDI value in the first group-common DCI to indicate the transmission 316 is a HARQ retransmission (i.e., the first HARQ transmission described above). For example, the second NDI can be a second default value. One of the first and second default values can be 0 and the other is 1. In some implementations, the base station 104 includes a particular HARQ process number in the first NDI to address a HARQ process that the UE 102 used to receive the HARQ new transmission m. In some implementations, the base station 104 can include the particular HARQ process number in the MBS SPS activation command(s) to configure the UE 102 to associate the HARQ new transmissions 1, . . . , m with the particular HARQ process number. In other implementations, the base station 104 does not include the particular HARQ process number in the MBS SPS activation command(s). In such cases, the UE 102 and base station 104 can use a predetermined HARQ process number which can be specified in a 3GPP specification, and the HARQ process number in the first group-common DCI is the predetermined HARQ process number.

In alternative implementations, the UE 102 and base station 104 can determine a particular HARQ process number for each of the HARQ new transmissions 1, . . . . , m after activating the SPS resources from a formula below.

HARQ Process number=[floor (CURRENT_slot×10/(numberOfSlotsPerFrame×periodicity))] modulo nrofHARQ-Processes. (1)

where CURRENT_slot=[(System Frame Number of a frame×numberOfSlotsPerFrame)+slot number in the frame] and numberOfSlotsPerFrame refers to the number of consecutive slots per frame which can be specified in 3GPP specification 38.211. The slot number identifies the slot where the base station 104 starts transmitting the HARQ new transmission m on the SPS resources occurs and the frame contains the slot. The base station 104 can include the configuration parameters numberOfSlotsPerFrame, periodicity and nrofHARQ-Processes in the MBS SPS configuration. The UE 102 and base station 104 determine the slot in accordance with the MBS SPS configuration and/or the MBS SPS activation command.

If the base station 104 includes a harq-ProcID-Offset in the MBS SPS configuration, the UE 102 and base station 104 can determine a particular HARQ process number for each of the HARQ new transmissions 1, . . . . , m after activating the SPS resources from a formula below:

HARQ Process number=[floor (CURRENT_slot×10/(numberOfSlotsPerFrame×periodicity))] modulo nrofHARQ-Processes+harq-ProcID-Offset. (2)

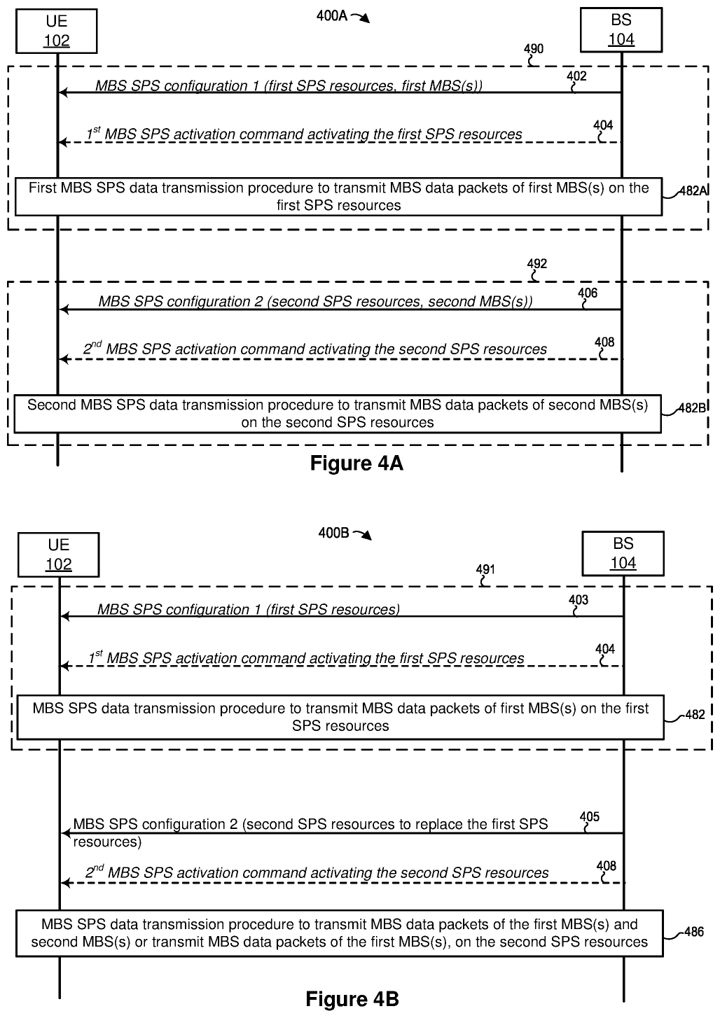

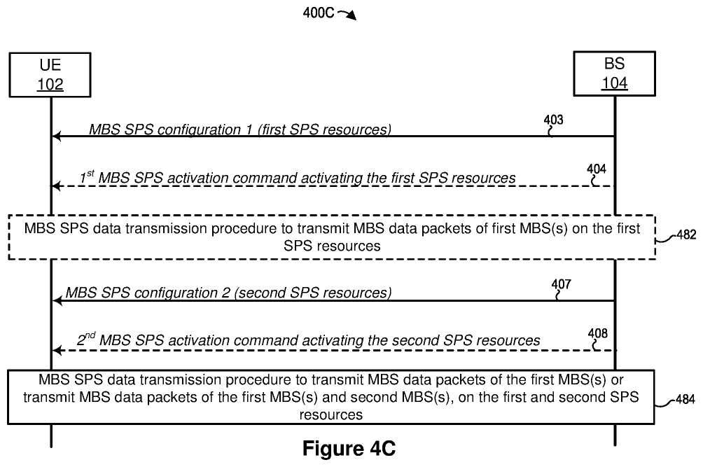

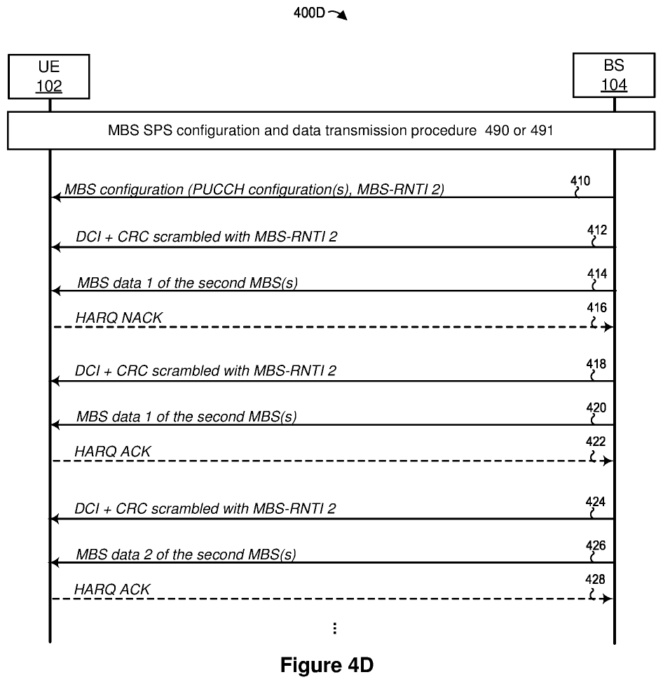

In some implementations, if the base station 104 sends multiple MBS SPS configurations to the UE 102 as described for FIG. 4A, the base station can include particular configuration parameters numberOfSlotsPerFrame, periodicity, nrofHARQ-Processes and/or harq-ProcID-Offset in each of the multiple MBS SPS configurations. For a configuration parameter in (some of) the multiple MBS SPS configurations, the base station 104 can set the configuration parameter to the same value or different values. For example, the base station 104 sends a first MBS SPS configuration (or “MBS SPS configuration 1”) and a second MBS SPS configuration (or “MBS SPS configuration 2”) to the UE 102 as described for FIG. 4A. A configuration parameter in the first and second MBS SPS configurations can be the same value or different values. The base station 104 may include the configuration parameter nrofHARQ-Processes in some of the multiple MBS configurations and does not include the configuration parameter in the rest of the multiple MBS configurations. If the base station 104 sends a unicast SPS configuration to the UE 102A, the base station 104 can include similar configuration parameters in the unicast SPS configuration. For a configuration parameter in the MBS SPS configuration and unicast SPS configuration, the base station 104 can set the configuration parameter to the same value or different values. The base station 104 may include the configuration parameter nrofHARQ-Processes in one of the MBS SPS configuration and unicast SPS configuration and does not include the configuration parameter in the other.

In some implementations, the base station 104 can include a third NDI value and a fourth NDI value in the second group-common DCI and third group-common DCI, respectively. The base station 104 can also include the same HARQ process number in the second group-common DCI and third group-common DCI. In one implementation, the base station 104 can set the third NDI value and the fourth NDI value to a third default value and a fourth default value, respectively. The default values can be specified in a 3GPP specification. For example, one of the third and fourth default values can be 0 and the other is 1. In another implementation, the base station 104 can set the third NDI value and the fourth NDI value to a toggled value and a untoggled value, respectively. For example, if a previously received NDI value for the HARQ process number is 0 before the UE 102 receives the second group-common DCI, the toggled value is 1 and the untoggled value is 1. If a previously received NDI value for the HARQ process number is 1 before the UE 102 receives the second group-common DCI, the toggled value is 0 and the untoggled value is 0.

In some implementations, if the UE 102 determines the second group-common DCI is valid with the third group-common RNTI, the UE 102 can determine that the transmission 322 is a HARQ new transmission (i.e., the HARQ new transmission n) addressed to a HARQ process that the UE 102 used to receive a HARQ new transmission on SPS resources or receive a HARQ retransmission (e.g., the first HARQ retransmission) for a HARQ new transmission (e.g., the HARQ new transmission m) that the UE 102 received on SPS resources. In such implementations, the UE 102 may disregard the third NDI value in the second group-common DCI, and the base station 104 can set third NDI value to either 0 and 1. If the third NDI value is 0, the base station 104 sets the fourth NDI value to 0, i.e., untoggled. If the third NDI value is 1, the base station 104 sets the fourth NDI value to 1, i.e., untoggled.

Now referring to FIG. 3C, a scenario 300C is similar to the scenario 300A, except that the base station 104 transmits a first SPS configuration to the UE 102A using dedicated resources for the UE 102A, and transmits a second SPS configuration to the UE 102B using dedicated resources for the UE 102B. Instead of broadcasting or multicasting an MBS SPS configuration to the UE 102, the base station 104 unicasts 301 a first MBS SPS configuration to the UE 102A and unicasts 303 a second MBS SPS configuration to the UE 102B. In some implementations, the base station 104 transmits (i.e., unicasts) 301, to the UE 102A, a first RRC message (e.g., an RRCConnectionReconfiguration message or an RRCReconfiguration message) including the first MBS SPS configuration and an indication to activate receiving MBS data in accordance with the first MBS SPS configuration (i.e., an activation indication). In some implementations, the activation indication is included in the first MBS SPS configuration. In such implementations, the activation indication may be an information element (IE), field, or flag. Alternatively, in such implementations, the activation indication may not be an explicit indication. Rather, reception of the first MBS SPS configuration (i.e., an SPS configuration that is for receiving MBS data) implicitly instructs the UE 102A to activate receiving MBS data in accordance with the first MBS SPS configuration. In response to receiving 301 the first RRC message, the UE 102A transmits a first RRC response message (e.g., an RRCConnectionReconfigurationComplete message or an RRCReconfiguration Complete message) to the base station 104.

The base station 104 also transmits 303 a second RRC message (e.g., an RRCConnectionReconfiguration message or an RRCReconfiguration message) to the UE 102B including the second MBS SPS configuration and an indication to activate receiving MBS data in accordance with the second MBS SPS configuration. In response to receiving 303 the second RRC message, the UE 102B transmits a second RRC response message (e.g., an RRCConnectionReconfigurationComplete message or an RRCReconfiguration Complete message) to the base station 104.

The first and the second MBS SPS configurations may be the same, or at least a portion of the first and the second MBS SPS configurations may be different. For example, both the first and the second MBS configurations may indicate the same periodicity T for SPS resources. Both the first and the second MBS configurations may also include the same configuration parameters numberOfSlotsPerFrame, nrofHARQ-Processes and/or harq-ProcID-Offset. Additionally, both the first and the second MBS configurations may include the same PDSCH configuration including configuration parameter(s) for receiving PDSCH transmissions including MBS data on SPS resources.

In some implementations, the base station 104 can transmit to the UE 102A a third RRC message (e.g., RRCConnectionReconfiguration message or an RRCReconfiguration message) including a first PUCCH resource configuration, which configures first PUCCH resources and includes the a first PUCCH resource identity/identifier (ID) identifying the first PUCCH resource configuration. The base station 104 can also transmit to the UE 102B a fourth RRC message (e.g., RRCConnectionReconfiguration message or an RRCReconfiguration message) including a second PUCCH resource configuration, which configures second PUCCH resources and includes the a second PUCCH ID identifying the second PUCCH resource configuration. For example, the third and fourth RRC messages can be RRCConnectionReconfiguration messages or an RRCReconfiguration messages. The base station 104 can include the first PUCCH resource ID and the second PUCCH resource ID in the first and second MBS SPS configurations, respectively. The first and third RRC messages can be the same (i.e., the same instance) or different. In cases that the first and third RRC messages are different, the UE 102A can send a third RRC response message to the base station 104 in response to the third RRC message. The second and fourth RRC messages can be the same (i.e., the same instance) or different. In cases that the second and fourth RRC messages are different, the UE 102A can send a fourth RRC response message to the base station 104 in response to the fourth RRC message. For example, the third and fourth RRC response messages can be RRCConnectionReconfigurationComplete messages or an RRCReconfigurationComplete messages. The base station 104 can include the first PUCCH resource ID in the first MBS SPS configuration to configure the UE 102A to use the first PUCCH resources, and include the second PUCCH resource ID in the second MBS SPS configuration to configure the UE 102B to use the second PUCCH resources.

In some implementations, the first and the second MBS configurations may include different PUCCH configurations configuring different radio resources (i.e., PUCCH resources) for the UE 102A and the UE 102B, respectively, to use to transmit HARQ ACKs or NACKs. Thus, the UE 102A and the UE 102 can transmit HARQ feedbacks (HARQ ACKs or NACKs) on different radio resources to the base station 104. The base station 104 can identify a HARQ feedback (i.e., HARQ ACK or NACK) from the UE 102A if the base station 104 receives the HARQ feedback from radio resources dedicated to the UE 102A, and identify a HARQ feedback (i.e., HARQ ACK or NACK) from the UE 102B if the base station 104 receives the HARQ feedback from radio resources dedicated to the UE 102B, as described for FIG. 3A. In such cases, the first PUCCH resources and the second PUCCH resources are exclusive or different.

In other implementations, the first and the second MBS SPS configurations may include the same PUCCH configuration configuring the same radio resources (i.e., the same PUCCH resources) for the UE 102A and the UE 102B, respectively, to use to only transmit HARQ NACKs. In such cases, the first PUCCH resource configuration and the second PUCCH resource configuration configure the same PUCCH resources. In some implementations, the first and second PUCCH resource IDs can be the same. In other implementations, the first and second PUCCH resources IDs can be different because the base station 104 may configure the first PUCCH resource ID in another PUCCH resource configuration for the UE 102B.

The events 301 and 303 are collectively referred to in this disclosure as an MBS configuration procedure 305.

Referring to FIG. 3D, after the MBS configuration procedure 305, the base station 104 can perform 383 the MBS SPS data transmission procedure in order to transmit MBS data to the UE 102A and the UE 102B, generally similar to the MBS SPS data transmission procedure 382. The base station 104 can additionally transmit 304 the MBS SPS activation command(s) to the UE 102 to enable the UE 102 to start receiving MBS data periodically as described for FIG. 3A.

In the MBS SPS data transmission procedure 383, the base station 104 generates a first HARQ retransmission from the MAC PDU including the MBS data m, generates a first UE-specific DCI allocating radio resources for the first HARQ retransmission, generates a CRC from the first UE-specific DCI, scrambles the CRC with a first UE-specific RNTI of the UE 102A, in response to the HARQ NACK 311. Then, the base station 104 can unicast 313 the first UE-specific DCI and scrambled CRC on a PDCCH to the UE 102A. In some implementations, the base station 104 can include a time domain resource assignment field to configure a time offset int the first UE-specific DCI. In other implementations, the base station 104 can also include, in the first UE-specific DCI, configuration parameters of a MCS, a new data indicator (e.g., value 0 or 1), a redundancy version, a PUCCH resource indicator, a transmit power control (TPC) command (e.g., for scheduled PUCCH), a virtual resource block (VRB)-to-PRB mapping, an identifier for DCI formats, and/or PDSCH-to-HARQ feedback timing indicator.

After transmitting 313 the first UE-specific DCI and scrambled CRC, the base station 104 transmits 315C the first HARQ retransmission on the radio resources configured by the first UE-specific DCI. In some implementations, the base station 104 can scramble the first HARQ retransmission with a first scrambling sequence and then transmit 315C the (scrambled) first HARQ retransmission. The base station 104 and UE 102 can derive the first scrambling sequence from a cell identity of cell 124 and/or the first UE-specific RNTI.

After the UE 102A receives the first UE-specific DCI and the scrambled CRC on the PDCCH, the UE 102 verifies the scrambled CRC by using the first UE-specific RNTI and the first UE-specific DCI. In some implementations, the UE 102A descrambles the scrambled CRC to obtain a descrambled CRC by using the first UE-specific RNTI. Then, the UE 102A obtains a computed CRC from the first UE-specific DCI. If the computed CRC is identical to the descrambled CRC, the UE 102A determines the first UE-specific DCI is valid. Otherwise, the UE 102A determines the first UE-specific DCI is invalid. In other implementations, the UE 102A obtains a computed CRC from the first UE-specific DCI and scrambled the computed CRC to obtain a scrambled, computed CRC by using the first UE-specific RNTI. If the scrambled, computed CRC is identical to the scrambled CRC received on the PDCCH, the UE 102A determines the first UE-specific DCI is valid. Otherwise, the UE 102A determines the first UE-specific DCI is invalid. If the first UE-specific DCI is valid, the UE 102A attempts to receive 315C the first HARQ retransmission in accordance with the first UE-specific DCI. In some implementations, the UE 102A can send 317 a HARQ ACK to the base station 104 if the UE 102A successfully decodes the first HARQ retransmission (e.g., obtains a MAC PDU from the first HARQ retransmission or from a combination of the HARQ new transmission m and the first HARQ retransmission). The UE 102B verified the first UE-specific DCI is invalid by using a second UE-specific RNTI of the UE 102B, because the base station 104 configures the second UE-specific RNTI with a different value from the first UE-specific RNTI. Thus, the UE 102B does not attempt to receive 315C the first HARQ transmission on the radio resources configured by the first UE-specific DCI.

After transmitting 306 the MBS data 1, the base station 104 generates a HARQ new transmission n from a MAC PDU including the MBS data n, and generates a second UE-specific DCI allocating (first) radio resources for the HARQ new transmission n, generates a CRC from the second UE-specific DCI, and scrambles the CRC with the first UE-specific RNTI and the second UE-specific RNTI to obtain a first scrambled CRC and a second scrambled CRC respectively. Then the base station 104 transmits (i.e., unicast) 319 the second UE-specific DCI and the first scrambled CRC on a first PDCCH to the UE 102A and 321 the second UE-specific DCI and the second scrambled CRC to the UE 102B on a second PDCCH, respectively. The value “n” can be a positive integer larger or smaller than the value “m”. The base station 104 can include similar fields or similar configuration parameters with same or different values in the second UE-specific DCI, similar to the first UE-specific DCI.

After transmitting 319 the second UE-specific DCI and first scrambled CRC and 321 the second UE-specific DCI and second scrambled CRC, the base station 104 transmits 322 the HARQ new transmission n on the radio resources configured by the second UE-specific DCI. After the UE 102A receives the second UE-specific DCI and the first scrambled CRC on the first PDCCH, the UE 102A verifies the first scrambled CRC by using the first UE-specific RNTI. In some implementations, the UE 102A descrambles the first scrambled CRC to obtain a descrambled CRC by using the first UE-specific RNTI. Then, the UE 102A obtains a computed CRC from the second UE-specific DCI. If the computed CRC is identical to the descrambled CRC, the UE 102A determines the second UE-specific DCI is valid. Otherwise, the UE 102A determines the second UE-specific DCI is invalid. In other implementations, the UE 102A obtains a computed CRC from the second UE-specific DCI, and scrambles the computed CRC to obtain a scrambled, computed CRC by using the first UE-specific RNTI. If the scrambled, computed CRC is identical to the first scrambled CRC received on the first PDCCH, the UE 102 determines the second UE-specific DCI is valid. Otherwise, the UE 102A determines the second UE-specific DCI is invalid. If the second UE-specific DCI is valid, the UE 102A attempts to receive 322 the HARQ new transmission n in accordance with the second UE-specific DCI. Similarly, after the UE 102B receives the second UE-specific DCI and the second scrambled CRC on the second PDCCH, the UE 102B verifies the second UE-specific DCI by using the second UE-specific RNTI in a similar manner as the UE 102A. If the second UE-specific DCI is valid, the UE 102B attempts to receive 322 the HARQ new transmission n in accordance with the second UE-specific DCI.

In some implementations, the base station 104 can scramble the HARQ new transmission n with a second scrambling sequence and then transmit 322 the (scrambled) HARQ new transmission n to the UE 102. The base station 104 and UE 102 can derive the second scrambling sequence from the cell identity of cell 124 and/or a group-common RNTI (e.g., the first, second or third group-common RNTI). The UE 102 descrambles the HARQ new transmission n by using the second scrambling sequence. In some implementations, the base station 104 can indicate, in the second UE-specific DCI, the UE 102 to use the group-common RNTI to derive a scrambling sequence (i.e., the second scrambling sequence). For example, the base station 104 can include a field in the second UE-specific DCI to indicate the UE 102 to use the group-common RNTI to derive a scrambling sequence. In another example, a DCI format of the second UE-specific DCI implicitly indicates the UE 102 to use the group-common RNTI to derive a scrambling sequence.

In some implementations, the base station 104 can transmit 322 the HARQ new transmission n at slot x+(n−1)T. In the second UE-specific DCI, the base station 104 can indicate the UE 102 to receive the HARQ new transmission n at slot x+(n−1)T. The UE 102 receives the HARQ new transmission n at slot x+(n−1)T in accordance with the second UE-specific DCI. The UE 102 receives 322 the HARQ new transmission n at slot x+(n−1)T on the radio resources configured by the second UE-specific DCI instead of on the SPS resources. In other implementations, the base station 104 can transmit 322 the HARQ new transmission n at slot k other than slot x+(n−1)T. The value “k” is a positive integer smaller than the value “m”. In such cases, the base station 104 can indicate the UE 102 to receive 322 the HARQ new transmission n at slot k in the second UE-specific DCI. The UE 102 receives 322 the HARQ new transmission n at slot k in accordance with the second UE-specific DCI. The UE 102 receives 322 the HARQ new transmission n at slot k on the radio resources configured by the second UE-specific DCI.

In some implementations, the base station 104 can generate a third UE-specific DCI allocating second radio resources for the HARQ new transmission n, generates a CRC from the third UE-specific DCI, and scrambles the CRC with the third UE-specific RNTI to obtain a third scrambled CRC. Then the base station 104 transmits (i.e., unicast) the third UE-specific DCI and the third scrambled CRC to the UE 102B on the second PDCCH instead of the second UE-specific DCI and the second scrambled CRC. The base station 104 can include similar fields or similar configuration parameters with same or different values in the third UE-specific DCI, similar to the first UE-specific DCI. After transmitting the third UE-specific DCI and third scrambled CRC, the base station 104 transmits 322 the HARQ new transmission n on the radio resources configured by the third UE-specific DCI.

After the UE 102B receives the third UE-specific DCI and the third scrambled CRC on the second PDCCH, the UE 102B verifies the third UE-specific DCI by using the second UE-specific RNTI in a similar manner as the UE 102A. If the third UE-specific DCI is valid, the UE 102B attempts to receive the HARQ new transmission n in accordance with the third UE-specific DCI.

In some implementations, the base station 104 can scramble the HARQ new transmission n with a third scrambling sequence and then transmit the (scrambled) HARQ new transmission n to the UE 102. The base station 104 and UE 102 can derive the third scrambling sequence from the cell identity of cell 124 and/or the second UE-specific RNTI. The UE 102 descrambles the HARQ new transmission n by using the third scrambling sequence. In some implementations, the base station 104 can indicate, in the third UE-specific DCI, the UE 102B to use the second UE-specific RNTI to derive a scrambling sequence (i.e., the third scrambling sequence). For example, the base station 104 excludes a field in the third UE-specific DCI to indicate the UE 102B to use the second UE-specific RNTI to derive a scrambling sequence. In another example, a DCI format of the third UE-specific DCI implicitly indicates the UE 102 to use the second UE-specific RNTI to derive a scrambling sequence.

In response to the HARQ NACK 325, the base station 104 generates a second HARQ retransmission from the MAC PDU including the MBS data n, generates a fourth UE-specific DCI allocating radio resources for the second HARQ retransmission, generates a CRC from the fourth UE-specific DCI, scrambles the CRC with the fourth UE-specific RNTI. Then, the base station 104 can unicast 327 the fourth UE-specific DCI and scrambled CRC on a PDCCH to the UE 102B. The base station 104 can include similar fields or similar configuration parameters with same or different values in the fourth UE specific common DCI, similar to the first UE-specific DCI.

After transmitting 327 the fourth UE-specific DCI and scrambled CRC, the base station 104 transmits 338D the second HARQ retransmission on the radio resources configured by the fourth UE-specific DCI. After the UE 102B receives the fourth UE-specific DCI and the scrambled CRC on the PDCCH, the UE 102B verifies the scrambled CRC by using the second UE-specific RNTI and the fourth UE-specific DCI. In some implementations, the UE 102B descrambles the scrambled CRC to obtain a descrambled CRC by using the second UE-specific RNTI. Then, the UE 102B obtains a computed CRC from the fourth UE-specific DCI. If the computed CRC is identical to the descrambled CRC, the UE 102B determines the fourth UE-specific DCI is valid. Otherwise, the UE 102 determines the fourth UE-specific DCI is invalid. In other implementations, the UE 102B obtains a computed CRC from the fourth UE-specific DCI, and scrambles the computed CRC to obtain a scrambled, computed CRC by using the fourth UE-specific RNTI. If the scrambled, computed CRC is identical to the scrambled CRC received on the PDCCH, the UE 102B determines the fourth UE-specific DCI is valid. Otherwise, the UE 102B determines the fourth UE-specific DCI is invalid. If the fourth UE-specific DCI is valid, the UE 102 attempts to receive 338D the second HARQ retransmission in accordance with the fourth UE-specific DCI.

In some implementations, the base station 104 can scramble the second HARQ retransmission with a third scrambling sequence and then transmit 338D the (scrambled) second HARQ retransmission. The base station 104 and UE 102B can derive the third scrambling sequence from a cell identity of cell 124 and/or the second UE-specific RNTI. The UE 102B descrambles the (scrambled) HARQ new transmission n by using the third scrambling sequence.

The events 319, 321, 322, 324, 325, 327, 338D, and 330 can be collectively referred to as an MBS non-SPS data transmission procedure 385, or an MBS dynamic transmission procedure. It is noted that the base station 104 can perform the procedure 385 along with the procedure 383 during a certain MBS session.

Referring to FIG. 3E, a scenario 300E is similar to the scenario 300C of FIG. 3C, but in this case the base station 104 uses a group-common RNTI to perform 315E the transmission of the MBS data m. More specifically, the base station 104 and UE 102 can derive the scrambling sequence from the group-common RNTI rather than from a cell identity of cell 124 and/or the first UE-specific RNTI, and scramble the HARQ retransmission using this scrambling sequence. After the base station 104 broadcasts 315E the retransmission of the MBS data m, both the UE 102 and the UE 102B can receive 315E the retransmission. The UE 102B can automatically provide 317 a positive HARQ acknowledgement because the UE 102B already received this transmission successfully (event 310).

FIG. 3F illustrates a scenario 300F similar to that of FIG. 3D, but in this case the base station 104 uses a group-common RNTI to perform 338F the transmission of the MBS data n. The base station 104 can derive the scrambling sequence from the group-common RNTI rather than from a cell identity of cell 124 and/or the first UE-specific RNTI, and scramble the HARQ retransmission using this scrambling sequence

Next, FIGS. 4A-4D illustrate several scenarios in which a base station manages multiple MBS services and/or multiple SPS configurations.

In an example scenario 400A, the base station 104 configures different respective SPS resources for different MBSs. The base station 104 and the UEs can maintain and use these MBS/SPS configurations in parallel, if desired. Alternatively, the UE 102 can stop receiving data associated with the first MBS and start receiving data associated with the second MBS.

In particular, the base station 104 first configures 402 at least the UE 102 with first SPS resources for a first MBS service. The base station 104 then activates 404 the MBS service and performs 482A an MBS transmission procedure. When the UE 102 does not receive a HARQ transmission, the base station 104 can perform a retransmission over a dynamic resource as discussed above. Moreover, when a certain MAC PDU exceeds the capacity of the corresponding SPS resource, the base station 104 can perform the procedure 383 discussed above, as a part of the procedure 482A. The events 402, 404, and 482A collectively define a first MBS session 490.

In the scenario 400A, the UE 102 can switch to another, different MBS from the first MBS. The UE 102 can stop receiving the first MBS and, to this end, send an RRC message to the base station 104 to indicate that the UE 102 is no longer interested in receiving the first MBS. In response to this indication, the base station 104 can send, to the UE 102, a DL RRC message with an indication to release the SPS for the first MBS, or send an MBS SPS deactivation command to the UE 102, to deactivate the first SPS resources.

The UE 102 can indicate that it is interested in receiving a second MBS, in the same RRC message that indicates no further interest in the first MBS. In other implementations, the UE 102 sends a separate, second RRC message to the base station 104, to indicate that the UE 102 is interested in the second MBS. In response to the indication that the UE 102 is interested in the second MBS, the BS base station can send 406 to the UE 102 the second MBS SPS configuration, and/or the second MBS SPS activation command activating 408 the second SPS resources.

Alternatively, the UE 102 can send a first NAS message to the CN 110 via the base station 104, to stop receiving the first MBS. In response to the first NAS message, the CN 110 can send a CN-to-BS message to the base station 104 to release configurations relevant to receiving the first MBS for the UE 102. In response to the CN-to-BS message, the base station 104 can send to the UE 102A a DL RRC message to release the first MBS SPS configuration and/or send to the UE 102A a MBS SPS deactivation command to deactivate the first SPS resources. In some implementations, the UE 102 can request receiving the second MBS in the first NAS message. In other implementations, the UE 102 can send to the CN 110, via the base station 104, a second NAS message to request receiving the second MBS. In response to the request to receive the second MBS, the CN can send a CN-to-BS message to request the BS to configure radio resources for the UE 102A to receive the second MBS. In response to the CN-to-BS message, the base station 104 can send 406 to the UE 102 the second MBS SPS configuration and/or the second MBS SPS activation command, activating the second SPS resources. The base station 104 then performs 482B an MBS transmission procedure. The events 406, 408, and 482B collectively define a second MBS session 492.

As an alternative to the scenario discussed above, the procedures 490 and 492 can occur in parallel or in any case with a certain overlap in time, so that the UE 102 can receive data of both the first MBS and the second MBS concurrently.

Now referring to FIG. 4B, in a scenario 400B, the base station 104 configures new SPS resources to replace previously configured SPS resources, for one or more MBSs. First, the base station 104 configures 403 at least the UE 102 with first SPS resources (unlike the configuration of event 402, the configuration of event 401 is not limited to a particular MBS). After activating 404 the first SPS resources, the base station 104 transmits 482 data associated with the first MBS over the first SPS resources. The events 403, 404, and 482 collectively define a first MBS session 491.

The base station 104 then provides 405 a second MBS SPS configuration (or “MSB SPS configuration 2”) to the UE 102, to replace the first SPS resources with second SPS resources. After the base station 104 activates 408 the second SPS resources, the base station 104 can transmit 486 data packets of the first MBS over the second SPS resources. In some cases, the base station 104 transmits 486 data packets of the first MBS as well as of a second MBS over the second SPS resources.

Next, FIG. 4C illustrates an example scenario 400C in which the base station 104 configures new SPS resources to augment previously configured SPS resources. In particular, the base station 104 provides 403 first SPS resources, activates 404 the first SPS resources, and subsequently provides 407 second SPSP resources to the UE 102. After activating 408 the second SPS resources, the base station 104 can transmit data packets associated with the first MBS using the first SPS and the second SPS resources. The base station 104 can augment SPS resources in this manner in response to determining that the first SPS resources can no longer accommodate the first MBS service, for example. In some cases, the base station 104 transmits data packets associated with the first MBS as well as a second MBS, over the first SPS resources and the second SPS resources.

FIG. 4D illustrates an example scenario 400D in which the base station 104 configures SPS resources for one MBS in accordance with the procedure 490 or 491, and then adds dynamic resources for another MBS. In particular, after performing the procedure 490 or 491, the base station 104 can provide 410 an MBS configuration including PUCCH configuration(s) and another (second) MBS RNTI. The base station 104 in this scenario then transmits 412 a DCI with a CRC scrambled using the second MBS-RNTI.

To handle failures to deliver MBS date using dynamic resources, the base station 104 can allocate further resources for HARQ retransmission. More specifically, the base station 104 can transmit 414 first data of the second MBS, receive 416 a negative HARQ acknowledgment, transmit 418 a DCI with an CRC scrambled using the second MBS-RNTI, and retransmit 420 the data in accordance with the DCI. After receiving 422 a HARQ ACK, the base station 104 can transmit 424 a DCI (with an CRC scrambled using the second MBS-RNTI) for the next data packet(s) of the second MBS, and transmit 426 the data packet(s) in accordance with the DCI.

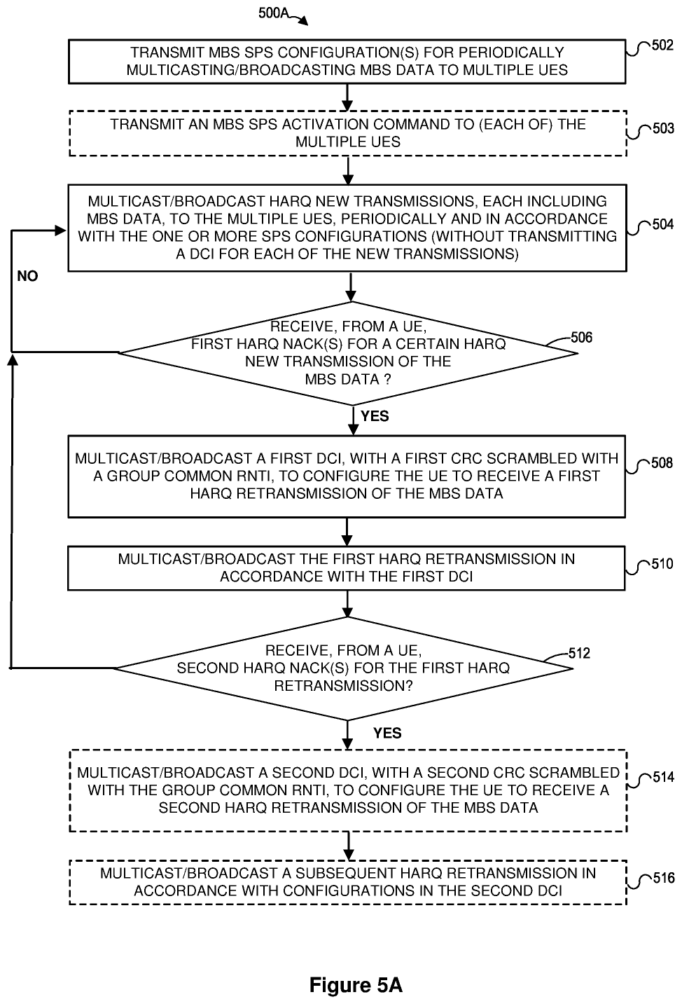

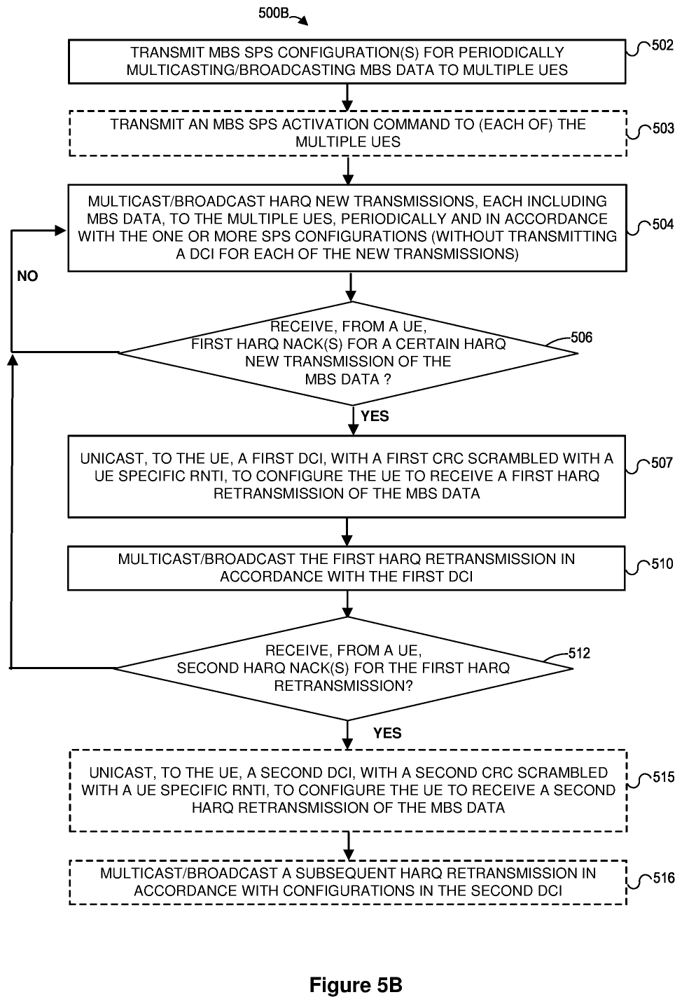

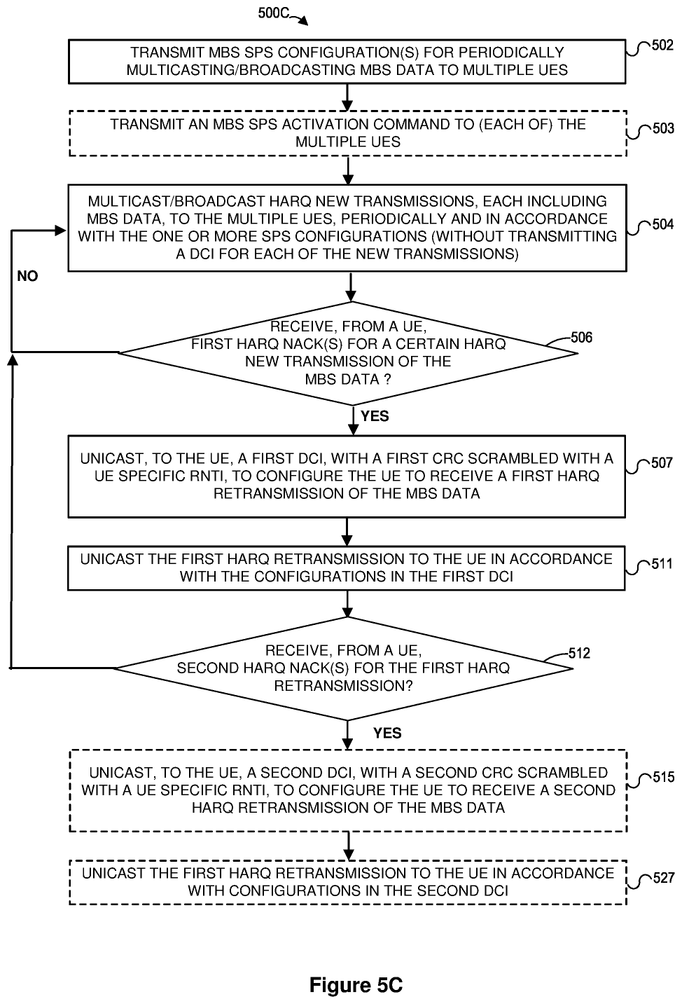

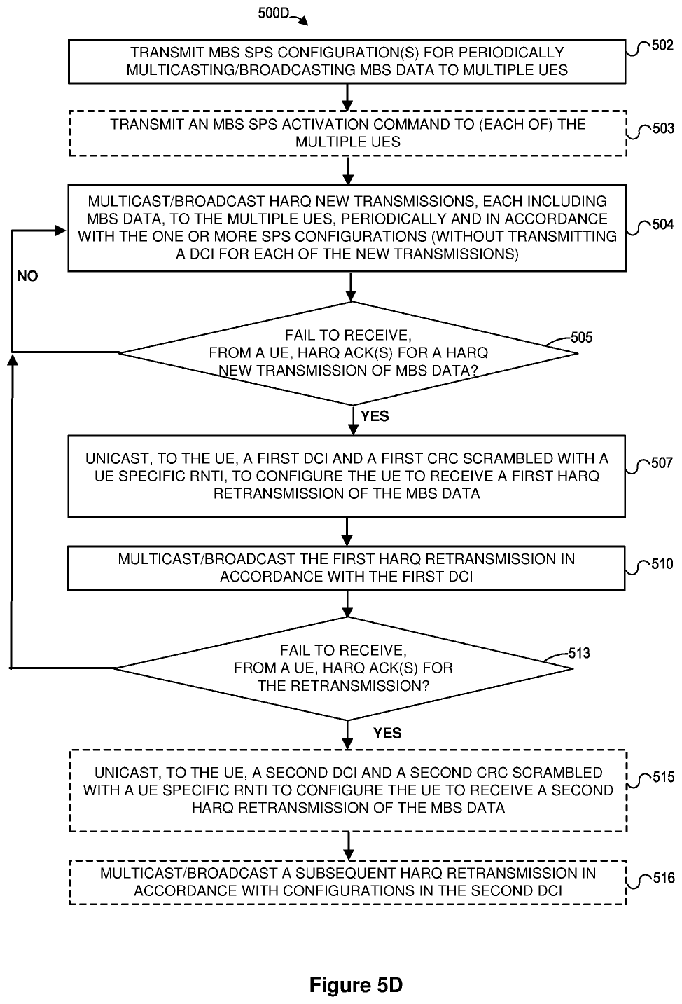

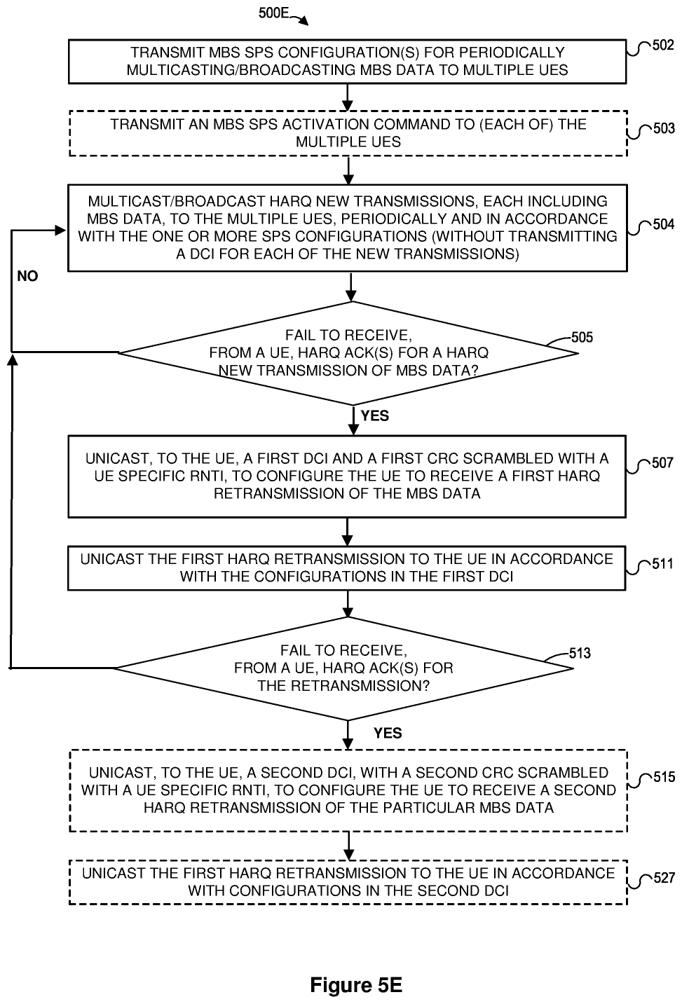

FIGS. 5A-E illustrate several example technique for generating DCIs, which can be implemented in the base station 104 or another suitable base station. Each of these methods can be implemented as a set of instructions executable by processing hardware (e.g., one or more processors) and stored on a non-transitory computer-readable medium.

Referring first to FIG. 5A, a method 500A begins at block 502, where the base station transmits, to multiple UEs, at least one MBS SPS configuration for periodically receiving multicast and/or broadcast data (e.g., events 301, 302, 402, 403). At block 503, the base station transmits an MBS SPS activation command to the UEs (e.g., events 304, 404). Next, at block 504, the base station 504 broadcasts or multicasts HARQ new transmissions (rather than retransmissions) to the UEs, in accordance with the SPS configuration (e.g., event 306). Because these transmissions occur in regularly scheduled timeslots otherwise over the SPS resources, the bases station does not transmit a DCI for each new transmission.

At block 506, the base station determines whether HARQ NACK has arrived from one or more of the UEs, for a certain HARQ new transmission. If no HARQ NACK has been received, the flow proceeds to block 504. Otherwise, the flow proceeds to block 508, where the base station broadcasts a first DCI, with a CRC scrambled with a group-common RNTI (e.g., MBS-RNTI, MBS-SPS-RNTI) (e.g., event 314). The base station then broadcasts or multicasts the first HARQ retransmission in accordance with the DCI, at block 510 (e.g., event 316).

If the base station then receives a second HAR NACK for the first HARQ retransmission (block 512), the flow proceeds to block 514. Otherwise, the flow returns to block 504. At block 514, the base station broadcasts a second DCI, with a CRC scrambled with a group-common RNTI (e.g., MBS-RNTI, MBS-SPS-RNTI). The base station then broadcasts or multicasts the subsequent HARQ retransmission in accordance with the DCI, at block 516. Thus, the base station in the scenario of FIG. 5A uses a temporary identity common to multiple UEs for dynamic broadcast of HARQ data.

Now referring to FIG. 5B, the flow in a method 500B proceeds from block 506 (“yes” branch) to block 507, where the base station unicasts a DCI scrambled with a UE-specific temporary identity to the UE that provided a negative acknowledgment. The base station then multi-casts or broadcasts the first HARQ retransmission in accordance with the DCI. The base station similarly generates a second DCI at block 515, in the event of a second HARQ NACK.

FIG. 5C is a flow diagram of an example method 500C that is similar to the method 500B of FIG. 5B, but the flow here proceeds from block 507 to block 511, where the base station unicasts the first HARQ retransmission to the UE. The base station similarly manages a retransmission at block 527. Thus, the base station implements the method 500C to unicast both the DCI and the HARQ retransmission to the UE that failed to receive an MBS transmission over an SPS resource (or multiple such UEs), whereas the method 500B includes unicasting only the DCI but not the data.

Next, FIG. 5D illustrates an example method 500D that is similar to the method 500B of FIG. 5B, but here the base station determines, at block 505, whether a positive HARQ ACK failed to arrive within a certain predetermined amount of time (e.g., a time period controlled by a HARQ ACK timer). Block 513 similarly replaces block 512 of FIG. 5B.

Next, FIG. 5E illustrates an example method 500E that is similar to the method 500C of FIG. 5C, but here the base station determines, at block 505, whether a positive HARQ ACK failed to arrive within a certain predetermined amount of time (e.g., a time period controlled by a HARQ ACK timer). Block 513 similarly replaces block 512 of FIG. 5B.

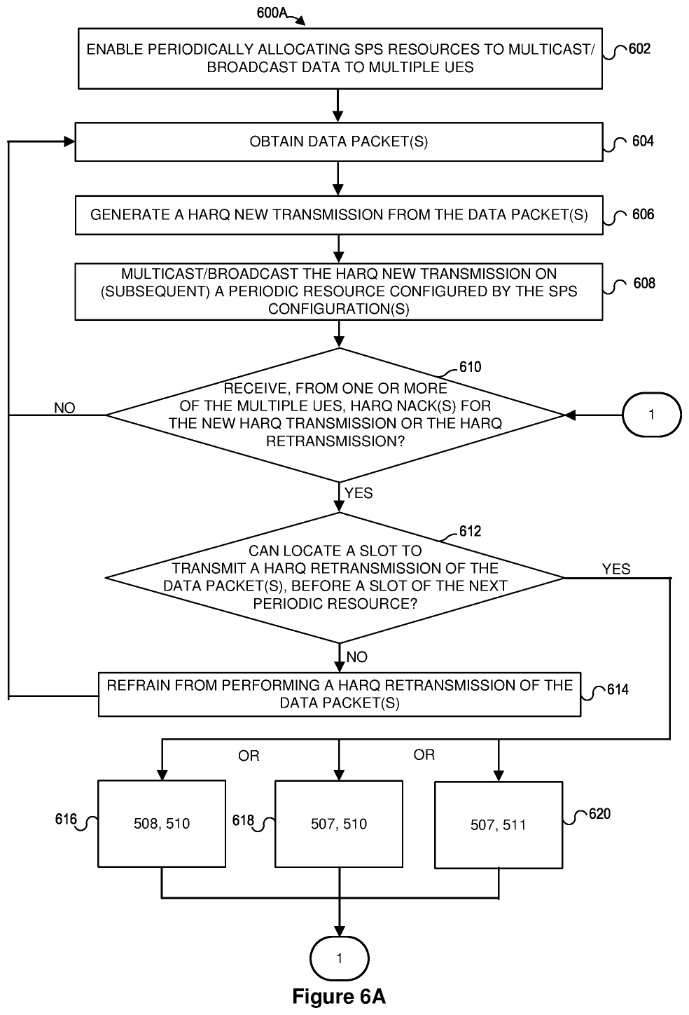

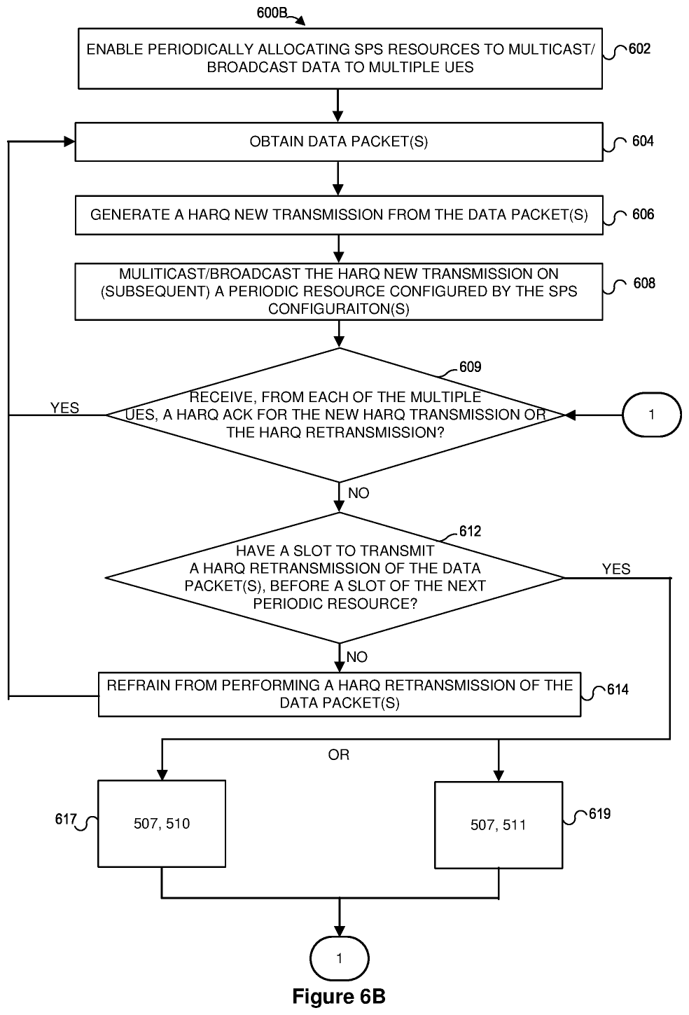

FIG. 6A is a flow diagram of an example method 600A which the base station 104 or a similar base station can implement to determine whether the base station 104 should perform a retransmission of MBS data using HARQ mechanism. At block 602, the base station enables periodic allocation of resources for MBS, in accordance with SPS techniques. At block 604, the base station obtains one or more data packet(s) for transmission to multiple UEs. For example, the base station can receive the data packet from the CN. At block 606, the base station generates a HARQ new transmission based on the one or more data packets.

Next, at block 608, the base station broadcasts or multicasts the HARQ new transmission on the next available resource included in the SPS resources. If, at block 610, the base station receives a HARQ NACK for the HARQ new transmission or for the HARQ retransmission, the proceeds to block 612. Otherwise, the flow returns to block 604.

At block 612, the base station determines whether a time slot for a HARQ retransmission is available prior to the next time slot included in the SPS resources. In other words, the base station determines whether dynamic allocation of a resource for HARQ retransmission may make the data packet untimely for the purposes of the MBS. In some cases, the base station can apply the method of FIG. 6A to only certain MBS types (e.g., audio but not video) or QoS values. The flow proceeds to block 614 if the base station cannot find a timely dynamic slot, and the base station refrains from performing a HARQ retransmission. Otherwise, the flow proceeds to one of blocks 616, 618, or 620, where the base station chooses a suitable retransmission technique: generating a DCI scrambled with a group-common RNTI or a UE-specific RNTI; a broadcast/multicast or a unicast for the DCI; a broadcast/multicast for the re-transmission; etc.

FIG. 6B illustrates an example method 600B similar to the method 600A, but with the base station determining whether it should perform a retransmission of MBS data based on whether a positive acknowledgement has failed to arrive from at least one of the UE (block 609).

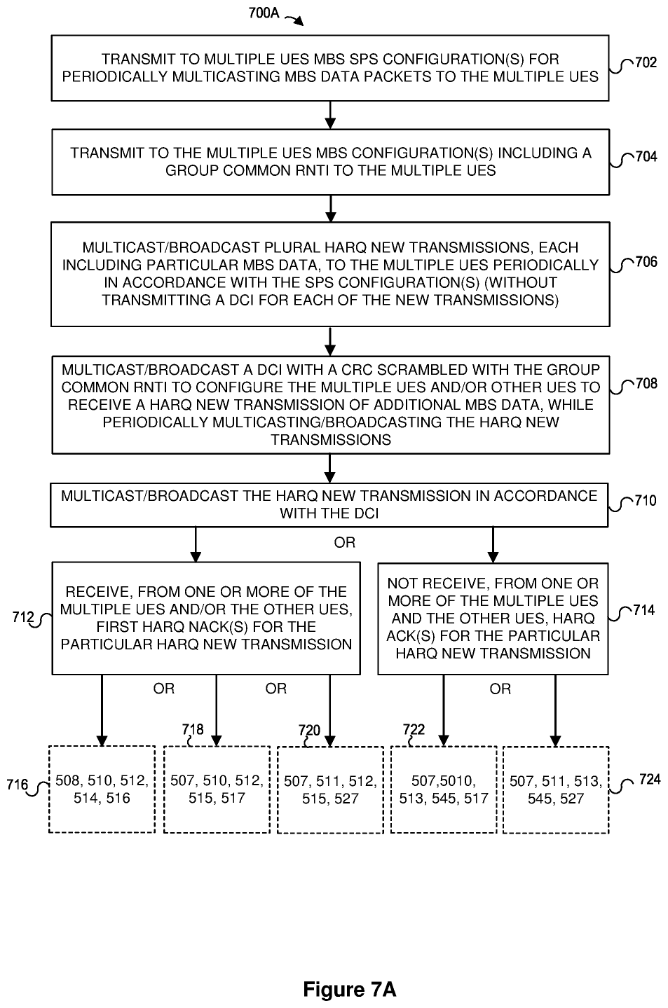

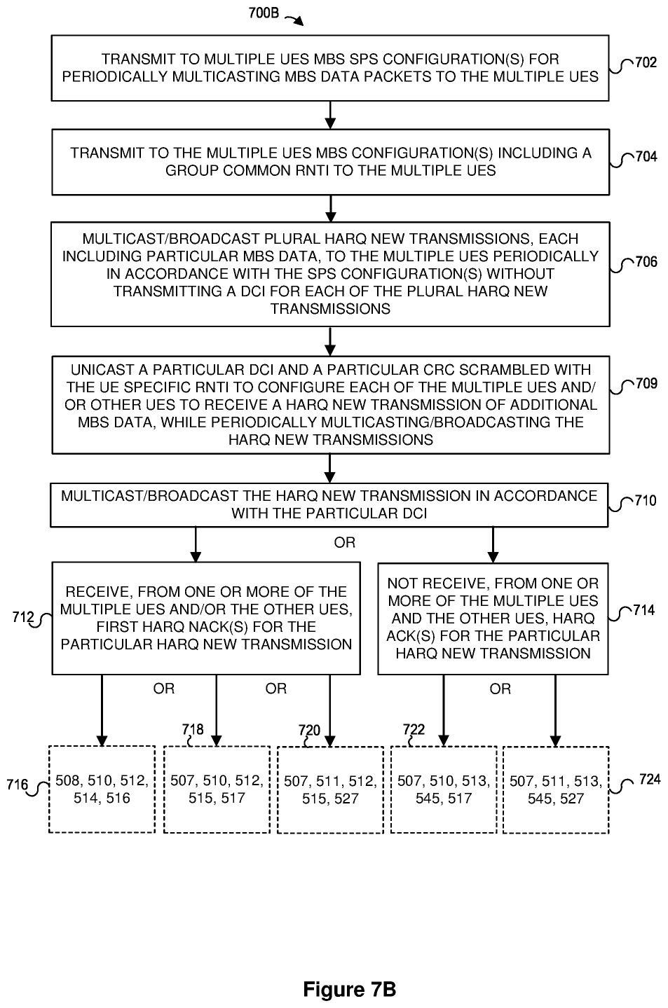

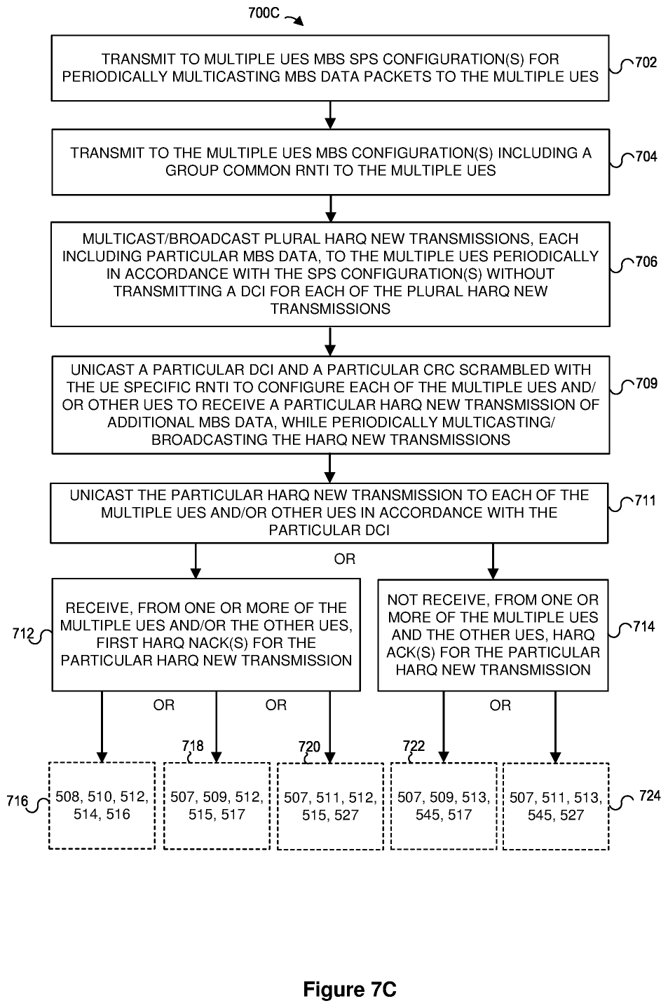

Now referring to FIG. 7A, a base station can implement a method 700A to select a group-common RNTI for dynamically augmenting SPS transmissions, and subsequently select a retransmission technique when one or more of the UEs fail to receive the dynamic transmission. The method 700A begins at block 702, where the base station transmits SPS configuration(s) to multiple UEs for periodically multicasting MBS data packets. The base station then transmits MBS configuration(s) and a group-common RNTI to the UEs. This identity can be for example an MBS-SPS RNTI or an MBS RNTI.

At block 706, the base station multicasts or broadcasts HARQ new transmissions, each including a respective portion of the MBS data, in accordance with the SPS configuration. At block 708, the base station multicasts or broadcasts a DCI with a CRC scrambled using the group common RNTI, to configure these UEs to receive additional MBS data. The base station and the UEs retain however the SPS resources and MBS transmission in accordance with the SPS. As discussed above, the base station can use this technique to accommodate a large transmission that exceeds the capacity of an SPS resource, or when the base station detects interference on the SPS resource.

At block 710, the base station multicasts or broadcasts the HARQ new transmission in accordance with the DCI. The base station continues transmitting MBS data using the SPS resources after completing block 710. However, if the base station receives a negative acknowledgement at block 712 of fails to receive the requisite positive acknowledgements at block 714 (depending on the implementation or configuration), the base station can perform a re-transmission at a block 716, 718, 720, 722, or 724. To this end, the base station can use one of the techniques discussed above with reference to FIGS. 5A-E.

FIG. 7B illustrates a similar method 700B, but here the base station uses a UE-specific RNTI for dynamically augmenting SPS transmissions, at block 709 (which replaces block 708 in the method 700A).

Further, FIG. 7C illustrates another similar method 700C, but in this case the base station uses a UE-specific RNTI at block 709, as well as unicast transmission(s) at block 711, to dynamically augmenting the SPS transmissions. As compared to the method 700A of FIG. 7A, the base station here performs blocks 709 and 711 rather than blocks 708 and 710.

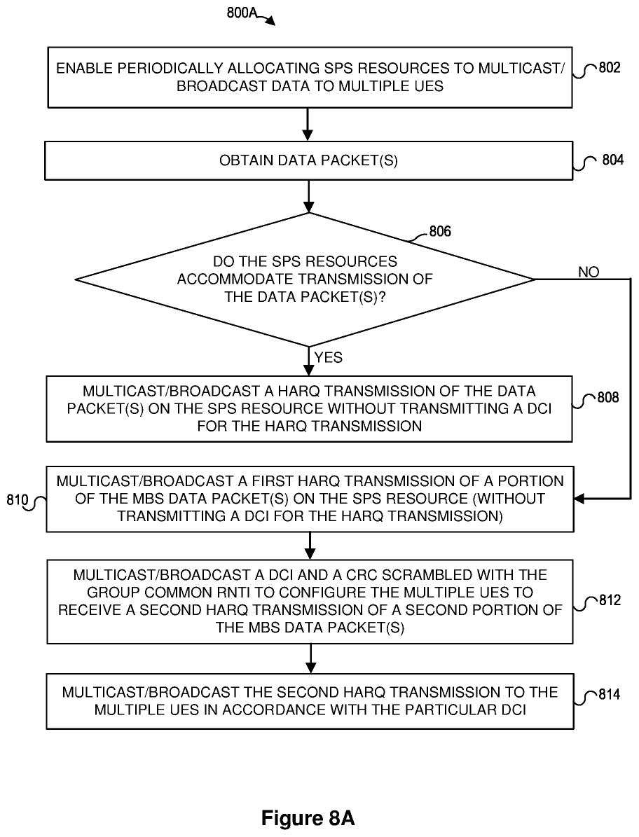

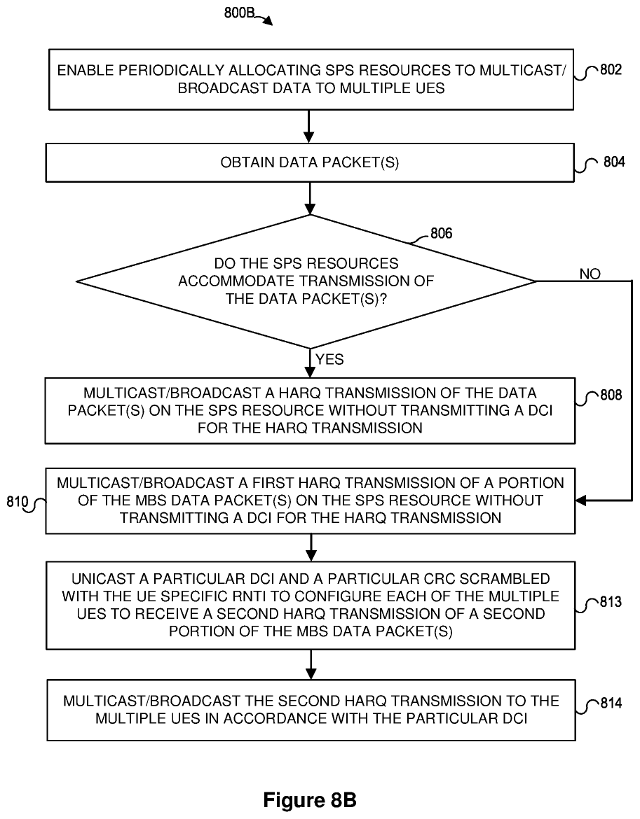

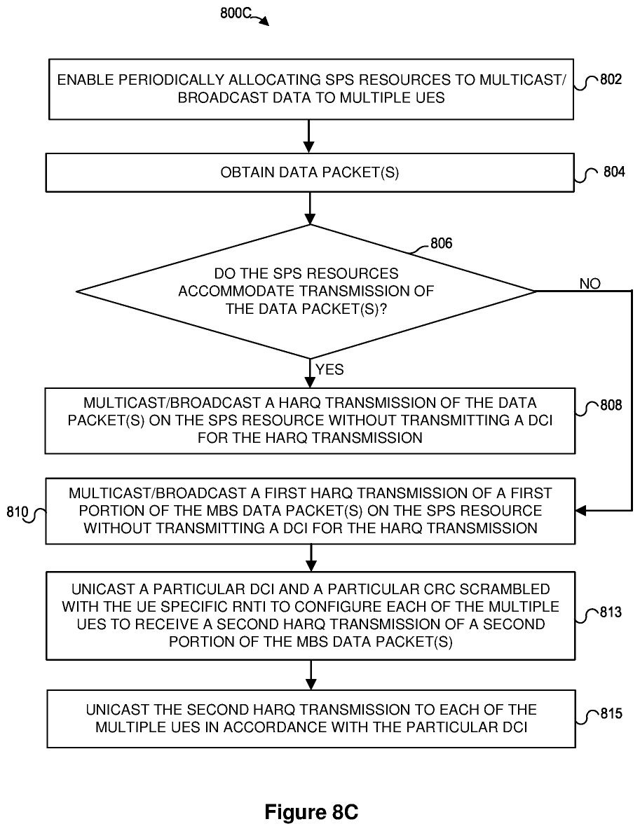

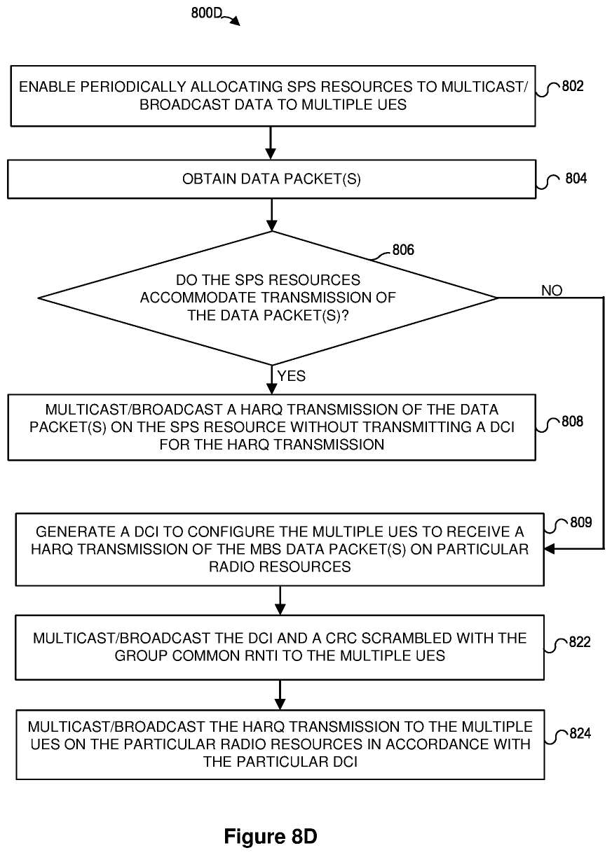

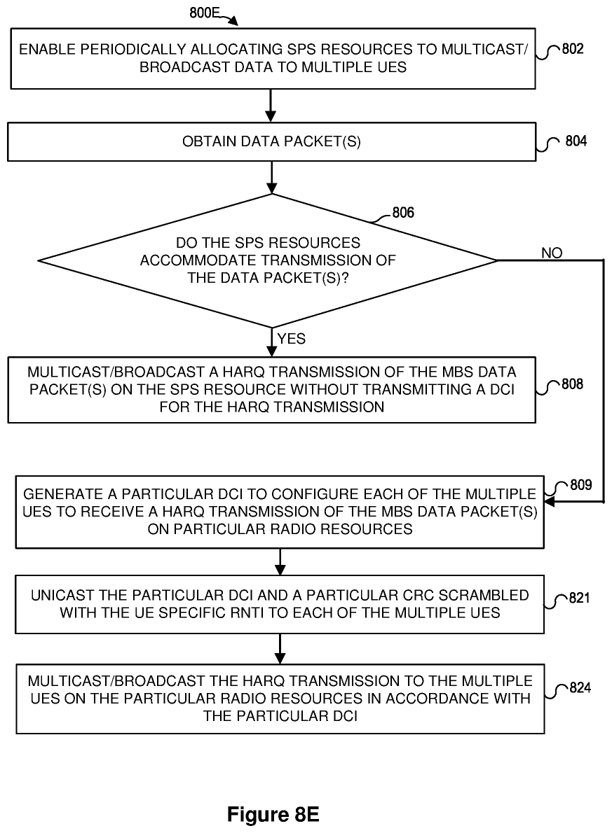

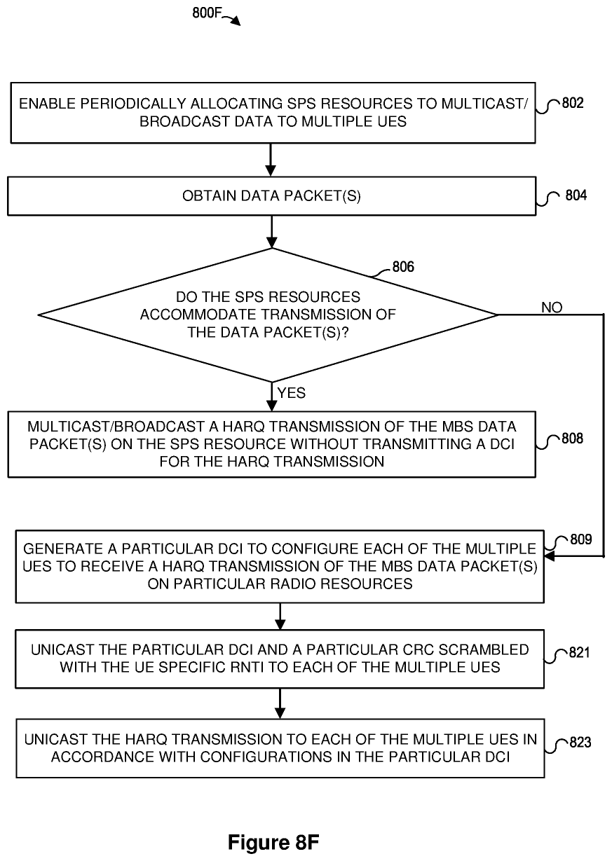

Next, FIG. 8A illustrates an example method 800A, in which blocks 802 and 804 are similar to blocks 602 and 604 discussed above. The base station then determines that a data packet associated with an MBS exceeds capacity of SPS resources (block 806) and, in response, configures a dynamic transmission for a portion of the data packet(s) at blocks 812-814. In particular, at block 810, the base station transmits a portion of the “large” data packet(s) using the SPS resources, scrambles a DCI with a group-common RNTI and transmits the DCI at block 812, and multicasts the second portion of the data packet in accordance with the DCI at block 814. Otherwise, if the data packet corresponds to the size of the SPS resource, the base station uses the SPS resource to transmit the entire packet(s) at block 808.

FIG. 8B illustrates a similar method 800B, but here the base station scrambles the CRC for a DCI using UE-specific RNTIs, at block 813. Further, FIG. 8C illustrates another similar method 800C, but here the base station both scrambles the CRC for a DCI using UE-specific RNTIs, at block 813, and unicasts HARQ transmissions corresponding to the DCI to the UEs, at block 815. Still further, FIG. 8D illustrates another similar method 800D, but here the base station uses a group-common RNTI (blocks 800 and 822) and multicasts the dynamic transmission of the data packet(s) at block 824.

FIG. 8E is a flow diagram of an example method 800E similar to that of FIG. 8D, but here the base station uses a UE-specific RNTI and multicast/broadcast techniques for the dynamic transmission of the entire “large” data packet, without using the SPS resources for this transmission (blocks 809, 821, 824). FIG. 8F is a flow diagram of an example method 800D similar to that of FIG. 8E, but here the base station unicasts the HARQ transmissions to the UEs at block 823.

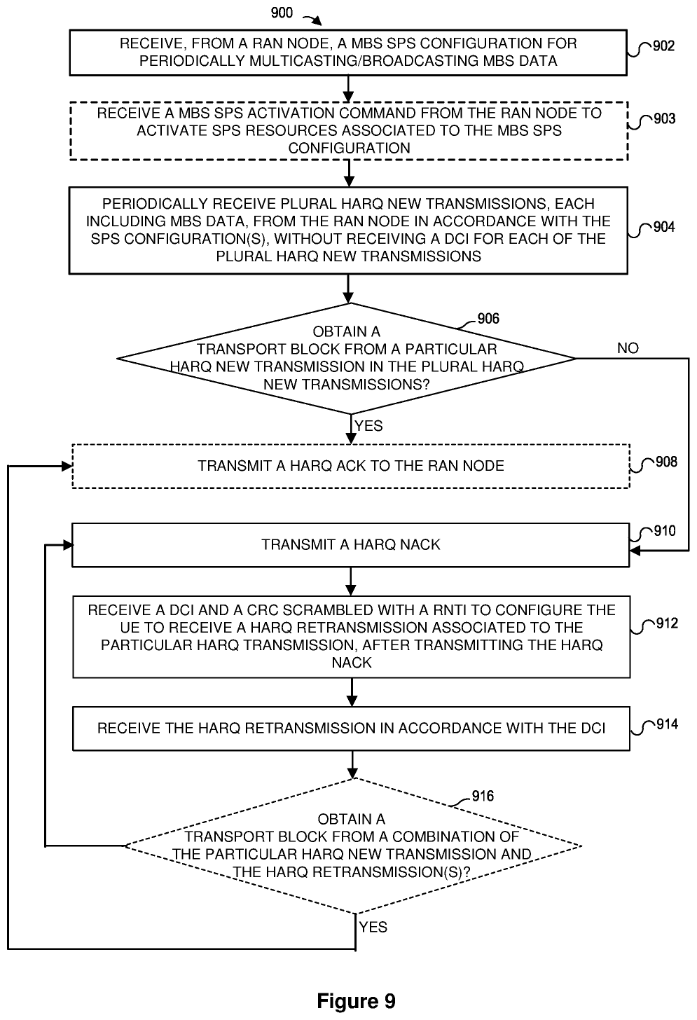

FIG. 9 is a flow diagram of an example method 900 according to which a UE transmits a negative acknowledgement (block 910) to an MBS transmission (block 904) upon failing to obtain a transport block (906) and receives, in response, an indication (block 914) that the base station has allocated a dynamic resource for retransmitting the MBS data.

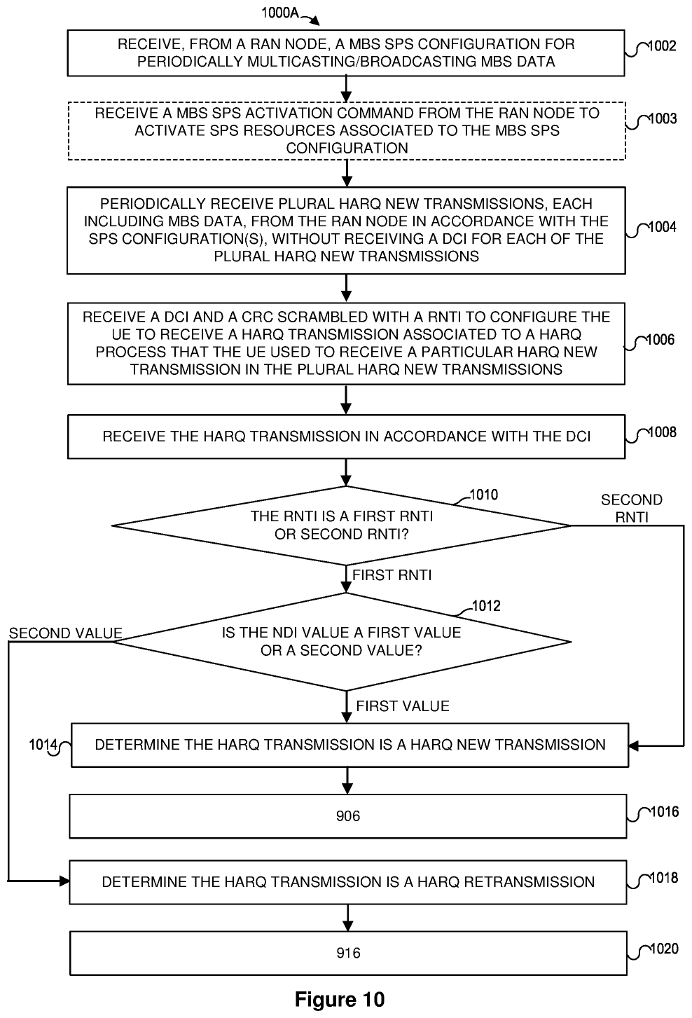

FIG. 10 is a flow diagram of an example method 1000 according to which a UE receiving MBS data in accordance with SPS (block 1004) and dynamic scheduling (block 1008), and determines the type of the dynamic transmission based on the temporary identifier the base station used (block 1010).

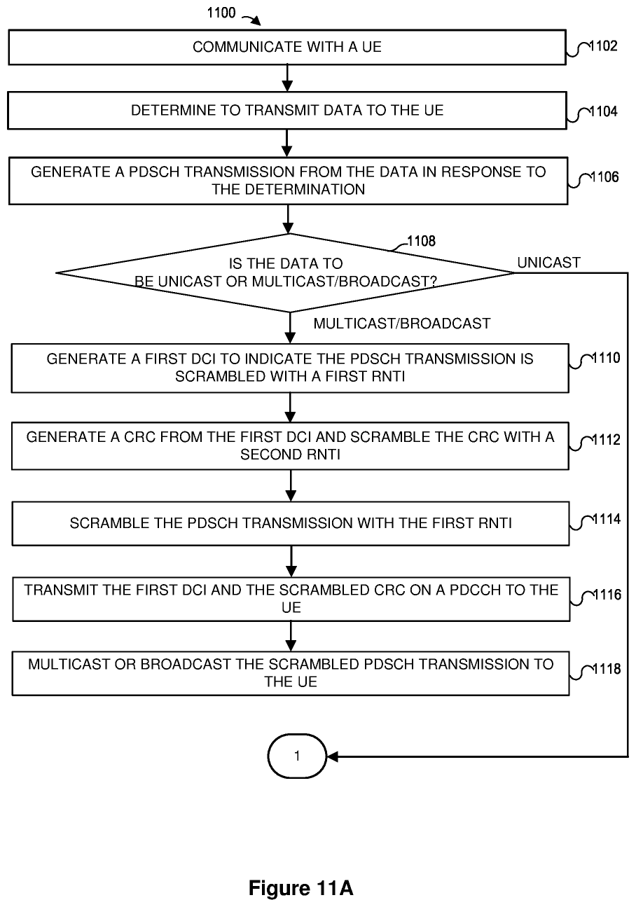

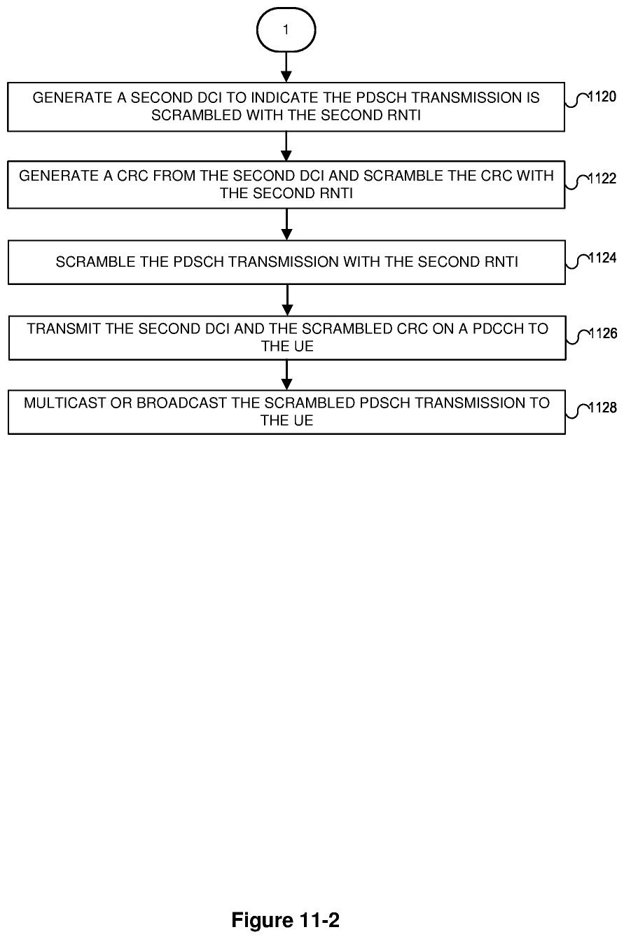

FIG. 11 is a flow diagram of an example method 1100 in a base station for selecting a temporary identifier for scrambling downlink transmissions (blocks 1110, 1120), depending on whether the data is for unicasting or multicasting/broadcasting (block 1108).

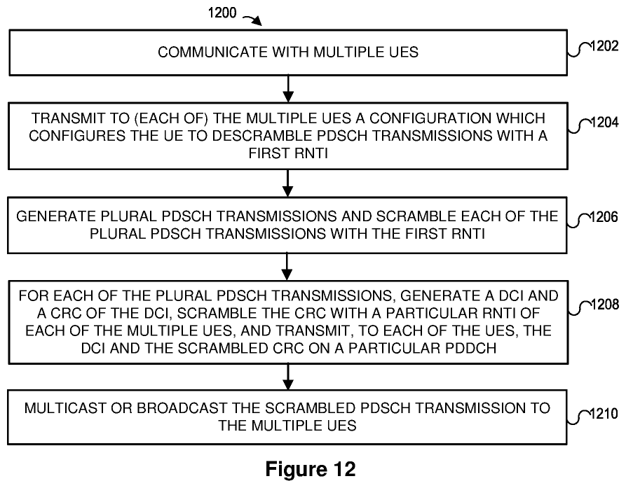

FIG. 12 is a flow diagram of an example method 1200 in a base station for transmitting MBS data (block 1210) to multiple UEs using a group-common RNTI for the data (block 1206) and UE-specific RNTIs for DCIs (block 1208).

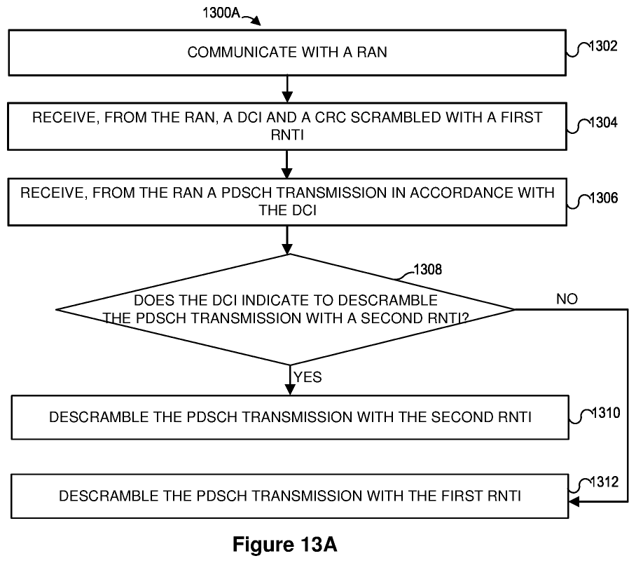

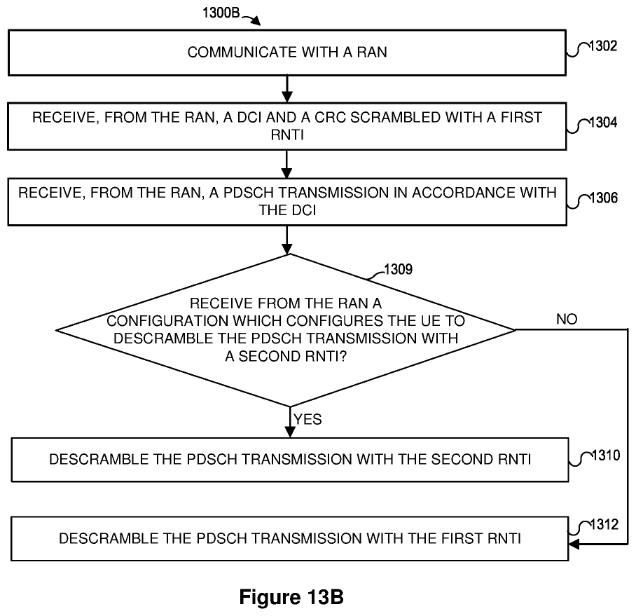

FIG. 13A is a flow diagram of an example method 1300A according to which a UE determines which RNTI the UE should use to receive MBS data (block 1310, 1312), based on an indication in the DCI (block 1308).

FIG. 13B is a flow diagram of an example method 1300B in a UE for determining which RNTI the UE should use to receive MBS data (block 1310, 1312), based on a configuration other than the DCI (e.g., an RRC message), received from the RAN (block 1309).

The following additional considerations apply to the foregoing discussion.

The “HARQ process number” can be replaced by a “HARQ process ID”. The “MBS SPS configuration” can be replaced by a “MBS configured downlink assignment configuration”.

In some implementations, the UE-specific DCI and the group-common DCI can have the same DCI format. In other implementations, the UE-specific DCI and the group-common DCI can have the different DCI formats. In some implementations, the content of the UE-specific DCI and the group-common DCI can have the same fields with the same values or different values. In other implementations, the content of the UE-specific DCI and the group-common DCI can have one or more different fields.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

The following list of examples reflects a variety of the embodiments explicitly contemplated by the present disclosure.
Example 1. A method in a base station for managing multicast and/or broadcast services (MBS), the method comprising: transmitting, by processing hardware, first data associated with a first MBS to a plurality of UEs, using semi-persistent scheduling (SPS) resources; and transmitting, by the processing hardware, second data associated with the first MBS or a second MBS to at least one of the plurality of UEs, using dynamic scheduling.
Example 2. The method of example 1, further comprising determining, by the processing hardware, that at least one of the plurality of UEs failed to receive a data packet included in the first data; wherein transmitting the second data includes retransmitting the data packet.
Example 3. The method of example 2, wherein transmitting the first data includes transmitting the data packet using a Hybrid Automatic Repeat Request (HARQ) mechanism retransmitting the data packet includes using the HARQ mechanism.
Example 4. The method of example 3, wherein determining that the at least one of the plurality of UEs failed to receive the data includes: receiving a negative HARQ acknowledgement.
Example 5. The method of example 3, wherein determining that the at least one of the plurality of UEs failed to receive the data includes not receiving a positive HARQ acknowledgement within a predetermined amount of time.
Example 6. The method of example 2, wherein retransmitting the data packet includes identifying an available time slot that occurs prior to an earliest time slot associated with the SPS resources for the MBS.
Example 7. The method of example 1, further comprising determining, by the processing hardware, that a size of one or more data packets associated with the first MBS exceeds a capacity of the SPS resources; and wherein transmitting the second data includes transmitting at least a portion of the one or more data packets.
Example 8. The method of example 7, including transmitting a first portion of the one or more data packets as a part of the first data using the SPS resources; and transmitting a second portion of the one or more data packets as the second data.
Example 9. The method of example 7, including not transmitting any portion of the one or more data packets using the SPS resources; and transmitting an entirety of the one or more data packets as the second data.
Example 10. The method of any of the preceding examples, further comprising transmitting a downlink control information (DCI) common to the plurality of UEs, to schedule the transmitting of the second data.
Example 11. The method of example 10, including scrambling the DCI using a temporary identifier shared by the plurality of UEs.
Example 12. The method of example 11, wherein the temporary identifier is a group radio network temporary identifier (RNTI).
Example 13. The method of example 11, wherein the temporary identifier is an MBS RNTI specifically assigned to the first MBS.
Example 14. The method of example 11, wherein the temporary identifier is an MBS-SPS-RNTI specifically assigned to the first MBS and the SPS resources.
Example 15. The method of any of the preceding examples, further comprising transmitting a DCI specific to one of the plurality of UEs, to schedule the transmitting of the second data.
Example 16. The method of example 15, including: scrambling the DCI using an RNTI specific to the one of the plurality of UEs.
Example 17. The method of any of examples 1-9, further comprising: transmitting a DCI to one or more of the plurality of UEs, including scrambling the DCI with a first RNTI; and

transmitting the second data to the one or more of the plurality of UEs in accordance with the DCI, including scrambling the second data with the second RNTI.
Example 18. The method of example 17, wherein one of the first RNTI and the second RNTI is common to the plurality of the UEs, and the other one of the first RNTI and the second RNTI is specific to one of the plurality of UEs.
Example 19. The method of any of the preceding examples, wherein transmitting the second data includes broadcasting or multicasting the second data to the plurality of UEs.
Example 20. The method of any of examples 1-18, wherein transmitting the second data includes unicasting the second data to one or more of the plurality of UEs.
Example 21. The method of any of the preceding example, wherein the SPS resources are first resources; the method further comprising: providing, to the plurality of UEs, second SPS resources; transmitting, by processing hardware, third data associated with a second MBS to the plurality of UEs, using the second SPS resources, concurrently with transmitting the first data.
Example 22. The method of any of examples 1-20, wherein: the SPS resources are first resources; the method further comprising: providing, by the processing hardware to the plurality of UEs, second SPS resources to replace the first resources.
Example 23. The method of example 22, further comprising, subsequently to providing the second SPS resources transmitting, by the processing hardware, the first data using the second SPS resources.
Example 24. The method of example 22, further comprising, subsequently to providing the second SPS resources transmitting, by the processing hardware, (i) the first data and (ii) third data associated with the second MBS, using the second SPS resources.
Example 25. The method of any of examples 1-20, wherein the SPS resources are first resources; the method further comprising providing, to the plurality of UEs, second SPS resources; transmitting, by processing hardware, third data associated with the first MBS to the plurality of UEs, using the second SPS resources, concurrently with transmitting the first data.
Example 26. The method of any of examples 1-20, wherein: the second data is associated with the second MBS.
Example 27. The method of any of the preceding examples, further comprising determining, by the processing hardware, that the at least one of the plurality of UEs failed to receive the second data; and retransmitting, by the processing hardware, the second data using dynamic scheduling.
Example 28. A method in a base station for managing MBS, the method comprising: transmitting, by processing hardware, first data associated with a first MBS to a plurality of UEs, using SPS resources; determining, by the processing hardware, that a UE included in the plurality of UEs failed to receive a data packet included in the first data; transmitting, by the processing hardware to the UE, a DCI scrambled using a temporary identifier specific to the UE; and retransmitting the data packet in accordance with the DCI and using the SPS resources.
Example 29. The method of example 28, wherein retransmitting the data packet includes scrambling the data packet using a second temporary identifier shared by the plurality of UEs.
Example 30. The method of example 28, wherein the second temporary

identifier is an MBS-RNTI.
Example 31. The method of example 28, wherein the temporary identifier is

a C-RNTI.
Example 32. A base station comprising processing hardware and configured to implement a method according to any of the preceding claims.
Example 33. A method in a UE for receiving MBS, the method comprising receiving, by processing hardware from a radio access network (RAN), first data associated with a first MBS, via SPS resources; and receiving, by the processing hardware from the RAN, second data associated with the first MBS or a second MBS, via a dynamically scheduled resource.
Example 34. The method of example 33, further comprising determining, by the processing hardware, that a HARQ transmission of a data packet included in the first data cannot be decoded; wherein receiving the second data includes receiving a HARQ retransmission of the data packet.
Example 35. The method of example 30, further comprising transmitting, by the processing hardware to the RAN, a HARQ negative acknowledgement for the data packet.
Example 36. The method of example 30, further comprising not transmitting, by the processing hardware to the RAN, a HARQ positive acknowledgement for the data packet, within a predefined period of time.
Example 37. The method of example 30, further comprising receiving, by the processing hardware and prior to receiving the second data, a DCI specifying a resource for the second data.
Example 38. The method of example 37, further comprising determining, based on the DCI, which RNTI the UE is to use to descramble the second data.
Example 39. The method of example 37, further comprising determining, based on the DCI, whether the second data is a HARQ new transmission or a retransmission.
Example 40. The method of example 37, further comprising receiving, from the RAN, a message associated with a protocol for controlling radio resources, the message indicating which RNTI the UE is to use to descramble the second data.
Example 41. A method in a UE for managing MBS, the method comprising receiving, by processing hardware from a RAN, first data associated with a first MBS, via SPS resources; providing, by the processing hardware to the RAN, an indication that the UE failed to receive a data packet included in the first data; receiving, by the processing hardware from the RAN, a DCI scrambled using a temporary identifier specific to the UE; and receiving a retransmission of the data packet in accordance with the DCI and via the SPS resources.
Example 42. The method of example 41, wherein receiving the retransmission of the data packet includes descrambling the data packet using a second temporary identifier the UE shares with at least one other UE.
Example 43. The method of example 42, wherein the second temporary identifier is an MBS-RNTI.
Example 44. The method of example 41, wherein the temporary identifier is a C-RNTI.
Example 45. A user equipment (UE) comprising processing hardware and configured to implement a method according to any of examples 33-44.

1. A method implemented in a base station for managing multicast and/or broadcast services (MBS), the method comprising:
transmitting first data associated with a first MBS to a plurality of UEs, using semi-persistent scheduling (SPS) resources;
determining that at least one of the plurality of UEs failed to receive a data packet included in the first data;
scrambling a downlink control information (DCI) using a group RNTI (G-RNTI) shared by the plurality of UEs;
transmitting the DCI to the plurality of UEs, to schedule transmitting of second data including the data packet, including setting an NDI value in the DCI to 1 to indicate a retransmission, and
transmitting second data associated with the first MBS to at least one of the plurality of UEs, using dynamic scheduling.

2. The method of claim 1, wherein:
transmitting the first data includes transmitting the data packet using a Hybrid Automatic Repeat Request (HARQ) mechanism;
retransmitting the data packet includes using the HARQ mechanism.

3. The method of claim 1, wherein the G-RNTI is a group configured scheduling RNTI (G-CS-RNTI).

4. The method of claim 1, further comprising:
determining that a size of one or more data packets associated with the first MBS exceeds a capacity of the SPS resources; and
wherein transmitting the second data includes transmitting at least a portion of the one or more data packets.

5. The method of claim 1, further comprising:
transmitting a DCI to one or more of the plurality of UEs, including scrambling the DCI with a first RNTI different from the G-RNTI.

6. The method of claim 1, wherein:
the SPS resources are first resources;
the method further comprising:
providing, to the plurality of UEs, second SPS resources;
transmitting third data associated with a second MBS to the plurality of UEs, using the second SPS resources, concurrently with transmitting the first data.

7. The method of claim 1, further comprising:
determining that the at least one of the plurality of UEs failed to receive the second data; and
retransmitting the second data using dynamic scheduling.

8. A base station comprising:
processing hardware configured to manage multicast and/or broadcast services (MBS), including:
transmit first data associated with a first MBS to a plurality of UEs, using semi-persistent scheduling (SPS) resources,
determine that at least one of the plurality of UEs failed to receive a data packet included in the first data,
scramble a downlink control information (DCI) using a group RNTI (G-RNTI) shared by the plurality of UEs,
transmit the DCI to the plurality of UEs, to schedule transmitting of second data including the data packet, including setting an NDI value in the DCI to 1 to indicate a retransmission, and
transmit second data associated with the first MBS to at least one of the plurality of UEs, using dynamic scheduling.

9. A method implemented in a UE for receiving MBS, the method comprising:
receiving, from a radio access network (RAN), first data associated with a first MBS, via SPS resources;
determining that a HARQ transmission of a data packet included in the first data cannot be decoded; and
receiving, from the RAN, a downlink control information (DCI) scrambled using a group RNTI (G-RNTI) the UE shares with at least one other UE, the DCI scheduling a dynamic transmission of second data; and
receiving, from the RAN, the second data associated with the first MBS or a second MBS, via a dynamically scheduled resource, including determining that the second data includes a HARQ retransmission of the data packet in response to determining that an NDI in the DCI is set to 1.

10-15. (canceled)

16. The base station of claim 8, wherein:
transmitting the first data includes transmitting the data packet using a Hybrid Automatic Repeat Request (HARQ) mechanism;
retransmitting the data packet includes using the HARQ mechanism.

17. The base station of claim 8, wherein:
the G-RNTI is a group configured scheduling RNTI (G-CS-RNTI).

18. The base station of claim 8, wherein the processing hardware is further configured to:
determine that a size of one or more data packets associated with the first MBS exceeds a capacity of the SPS resources; and
wherein transmitting the second data includes transmitting at least a portion of the one or more data packets.

19. The base station of claim 8, wherein the processing hardware is further configured to:
transmit a DCI to one or more of the plurality of UEs, including scramble the DCI with a first RNTI different from the G-RNTI.

20. The base station of claim 8, wherein:
the SPS resources are first resources;
the processing hardware further configured to:
provide, to the plurality of UEs, second SPS resources;
transmit third data associated with a second MBS to the plurality of UEs, using the second SPS resources, concurrently with transmitting the first data.

21. The base station of claim 8, wherein the processing hardware is further configured to:
determine that the at least one of the plurality of UEs failed to receive the second data; and
retransmit the second data using dynamic scheduling.

22. The method of claim 9, wherein the G-RNTI is a group configured scheduling RNTI (G-CS-RNTI).
